(19) United States
(12) Patent Application Publication
(10) Pub. No.: US 2025/0377473 A1
(43) Pub. Date: Dec. 11, 2025

(54) CROSS-WELL SEISMIC TOMOGRAPHY AND STRUCTURAL IMAGING LEVERAGING FULL WAVEFORM INVERSION

(71) Applicant: Schlumberger Technology Corporation, Sugar Land, TX (US)

(72) Inventors: Olga Podgornova, Belmont, MA (US); Joel Herve Le Calvez, Sugar Land, TX (US); Shujaat Ali, Richmond, TX (US); Lin Liang, Belmont, MA (US); Takashi Mizuno, Houston, TX (US); Pierre Bettinelli, Bucharest (RO); Smaine Zeroug, Lexington, MA (US)

(21) Appl. No.: 18/735,011

(22) Filed: Jun. 5, 2024

(51) Int. Cl. G01V 1/42; E21B 43/11; E21B 43/26; E21B 49/00

(52) U.S. Cl. CPC G01V 1/42; E21B 43/11; E21B 43/26; E21B 49/00; E21B 2200/20; G01V 2210/6222; G01V 2210/66; G01V 2210/74

(57) ABSTRACT

Systems and methods for using cross-well seismic data to image reservoir structures illuminated with sources located in a lateral well and receivers located in one or more nearby lateral wells. The systems and methods include numerical FWI algorithms and workflows based on an elastic vertical transverse isotropy (VTI) anisotropic full waveform inversion (EFWI) engine. The EFWI engine is used for inversions based on the cross-well seismic data and additional data (e.g., well logs, vertical seism profiles). Inversion results include 2D/3D maps of elastic properties (e.g., velocity, anisotropy, density, attenuation) of subsurface. The EFWI engine includes a wave propagation modeling accounting for various seismic waves propagating in the subsurface.

### BACKGROUND INFORMATION

This disclosure relates to systems and methods for imaging subsurface structures using cross-well seismic data. More specifically, aspects of the disclosure provide for imaging reservoir structures illuminated with use of sources located in a well and receivers located in other nearby wells.

Hydrocarbon resources, such as oil and gas deposits, are present in the strata of the Earth's crust. The hydrocarbon resources may be accessed by various drillings (e.g., drilling vertical or horizontal wells into the crust). In certain cases, a good understanding of the strata (e.g., physical properties of subsurface geologic formations) in close proximity to a proposed target area (e.g., an area including a reservoir) may help to minimize drilling risks and/or optimize hydrocarbon extractions. However, direct observations of the subsurface geologic formations may be difficult.

In certain cases, hydraulic fracturing for a stimulation of a reservoir may be used to extract the hydrocarbon resources from the reservoir. The hydraulic fracturing (or fracking) is a well stimulation technique including a fracturing of certain type of subsurface formations (e.g., bedrock formations) by using a pressurized liquid. For example, the hydraulic fracturing may include a high-pressure injection of a fracturing fluid into a wellbore to create cracks in the subsurface formations. Through the created cracks, reservoir fluids, such as natural gas and oil, may flow more freely to a production well.

Hydraulic fracturing may include an injection of a high viscosity fracturing fluid at a high flow rate to open and propagate a bi-wing tensile fracture in the subsurface formations. With the exception of the near-wellbore region where a complex state of stress might develop, the tensile fracture may propagate normal to a far-field least compressive stress. The length of the tensile fracture may attain, for example, several hundred meters during a fracturing treatment of several hours.

A fracturing fluid may contain proppants, such as well-sorted small particles added to the fluid to maintain a fracture opening once the pumping is stopped and pressure is released. This may allow for creating a high conductivity drain in the formation. These particles may include sand grains or ceramic grains. At the end of the fracturing treatment, a fracture fully packed with proppants may be obtained. The production of the hydrocarbons (e.g., reservoir fluids) may occur through the proppant packed fracture. A hydraulic conductivity (or fracture conductivity) of the proppant packed fracture may be given by a proppant pack permeability and a fracture width (e.g., retained fracture width after the fracturing treatment).

Hydraulic fracturing may be applied in low-permeability, gas-saturated formations (e.g., unconventional gas reservoirs), such as tight-gas sandstones, coal bed methane, and gas shales. Darcy units (e.g., millidarcy, microdarcy, nanodarcy) may be used as units of permeability. For example, the permeability of tight-gas sandstones may be of the order of hundreds of microdarcies, and the permeability of gas shale may be of the order of hundreds of nanodarcies. Such unconventional gas reservoirs may not produce reservoir fluids without the stimulations.

In low-permeability, gas-saturated formations, field observations of fracturing treatment may not always support the concept of the creation of the commonly accepted bi-wing tensile fracture. For example, in certain mine-back experiments, information obtained from laterals drilled across previously hydraulically fractured zones and records of micro-seismic events during a stimulation treatment may indicate a creation of a complex fracture network geometry including a complex fracture pattern. The actual cause of this complex fracture pattern may not be fully established, but the mine-back experiments, including those done for mining applications and field observations of natural hydraulic fractures, indicate that natural fractures and weak bedding planes may prevent the creation of a single tensile fracture and promote the creation of fracture offsets and multi-branched fractures.

Certain cases may support a theory explaining the cause of the complex fracture pattern, such as cases in some shale rocks where tensile natural fractures are not aligned with a current principal stress direction because they were created in an era where the stress directions were different. In certain cases, an assumption may be used such that a majority of the newly induced fractures (e.g., by the stimulation treatment) propagates normal to the far-field least compressive stress, creating the so-called fracture “fairway”, while shear fractures, mainly through the reactivation of pre-existing discontinuities, bedding planes and natural faults are expected.

The complex fracture pattern described above may have certain impacts on a design of the fracturing treatment. For instance, the fracture width of each branch of the complex fracture network may be smaller than that of a single fracture, and the proppant may not be able to be transported to an entire length of the complex fracture network.

Shear displacements along pre-existing discontinuities or induced shear fractures may occur, which, in turn, may increase the fracture conductivity (e.g., due to dilatancy effects) without the fracture being fully propped. In some cases, a pressure response during the stimulation treatment may be different from that of a bi-wing fracture

To estimate a production following the stimulation treatment in the complex reservoir where the fracture fairway is created, an assumption may be made such that the stimulation treatment creates an enhanced permeability zone of about a size a micro-seismicity cloud (referred to as Effective Stimulation Volume (ESV)) for an estimated stimulated zone. The ESV may be defined as the reservoir volume which is contacted by the stimulation treatment as determined by a micro-seismic event location and density. However, in some cases, it may not be linked to the enhanced permeability zone. In such cases, an actual conductive zone may be smaller than the ESV because the proppant may not be transported very far from the wellbore. For example, a fracture complexity may create pinch points that may restrict the proppant transportations.

The use of low viscosity fluid with poor transportation property compounds may result in a problem of poor proppant placement. In some cases, it remains unclear whether an unpropped fracture may be conductive, such as in a case where an amount of shear along a fracture plane is limited. As a result, an estimated production using the ESV may not be based on sound measurement of the actual conductive zone. Moreover, it may be difficult to properly evaluate and optimize an efficiency of the stimulation treatment.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one non-limiting embodiment, a method for processing cross-well seismic data based on elastic full waveform inversion includes constructing, via an inversion engine, an initial subsurface model indicative of parameters associated with a subsurface formation in an area. The method also include recording, via a monitoring tool deployed in a second well located in the area, a first set of seismic waves propagating through a fractured area as a first set of perforation events that occur when a first well is perforated via perforation equipment deployed in the first well. Moreover, the method includes recording, via the monitoring tool, a first set of induced micro-seismic waves as a first set of induced micro-seismic events that occur when the first well is stimulated via stimulation equipment deployed in the first well. Furthermore, the method includes generating, via a seismic recorder, cross-well seismic data comprising the first set of perforation events and the first set of induced micro-seismic events. Additionally, the method includes performing, via the inversion engine, an elastic full waveform inversion based on the cross-well seismic data to update the initial subsurface model, wherein updating the initial subsurface model comprises inverting the set of parameters and generating a final subsurface model.

In one non-limiting embodiment, a system for acquiring cross-well seismic data and processing the cross-well seismic data based on elastic full waveform inversion includes a seismic data acquisition system and a seismic data processing system. The seismic data acquisition system is configured to acquire the cross-well seismic data in an area including a subsurface formation. The seismic data acquisition system includes perforation equipment and monitoring equipment. The perforation equipment is deployed in a first well located in the area and configured to perforating a first well located in the area to generate seismic waves propagating through a fractured area in the subsurface formation. The monitoring equipment is deployed in a second well located in the area and configured to record the seismic waves as a set of perforation events. The seismic data processing system is configured to process the cross-well seismic data. The seismic data acquisition system includes a parameter setup module configured to define and initialize processing parameters and geological parameters associated with the subsurface formation in an area, a model building module configured to construct an initial subsurface model indicative of the geological parameters, a data decomposition module configured to decompose at least a portion of the cross-well seismic data into inline and crossline components based on the processing parameters, multiple denoise modules configured to reduce seismic noises contaminations in the inline and crossline components based on the processing parameters, an inversion module configured to perform an elastic full waveform inversion to generate a final subsurface model based on denoised inline and crossline components and the processing parameters, and an imaging module configured to perform a tomographic imaging of hydraulic fracture characterizations based on the final subsurface model to generate three-dimensional images associated with the fractured area. The elastic full waveform inversion is configured to invert the geological parameters to update the initial subsurface model.

In one non-limiting embodiment, a non-transitory computer-readable medium includes instructions that, when executed by one or more processors, cause the one or more processors to receive cross-well seismic data acquired from multiple lateral wells located in an area comprising a subsurface formation, determine processing parameters and geological parameters associated with the subsurface formation based on the cross-well seismic data, construct an initial subsurface model indicative of the geological parameters, decompose at least a portion of the cross-well seismic data into inline and crossline components based on the processing parameters, denoise the inline and crossline components to reduce seismic noise contaminations, invert the geological parameters to update the initial subsurface model based on the denoised inline and crossline components using an elastic full waveform inversion, generate a final subsurface model based on the inverted geological parameters, and generate subsurface images associated with a fractured area comprising fractures in the subsurface formation.

### BRIEF DESCRIPTION OF THE DRAWINGS

Various aspects of this disclosure may be better understood upon reading the following detailed description and upon reference to the drawings, in which:

FIG. 1 is a schematic diagram of a seismic survey and a data processing system using cross-well seismic data, in accordance with embodiments of the present disclosure;

FIG. 2 is an example of a cross-well seismic configuration that may be used to image a hydraulically fractured zone, in accordance with embodiments of the present disclosure;

FIG. 3 is an example of a seismic field survey using the cross-well seismic configuration of FIG. 2 and results from a multi-stage hydraulic fracturing treatment, in accordance with embodiments of the present disclosure;

FIG. 4 is a first block diagram of a processing scheme that may be used in the data processing system of FIG. 1, in accordance with embodiments of the present disclosure;

FIG. 5 is a schematic diagram of one-dimensional (1D) vertical transverse isotropy (VTI) anisotropic elastic horizontally layered medium in a three-dimensional (3D) volume, in accordance with embodiments of the present disclosure;

FIG. 6 is a schematic diagram of a wave decomposition including a six-component data orientation, in accordance with embodiments of the present disclosure;

FIG. 7 is a schematic diagram of a two-dimensional (2D) seismic acquisition, in accordance with embodiments of the present disclosure;

FIG. 8 depicts examples of computed wavefields using the wave decomposition of FIG. 6, in accordance with embodiments of the present disclosure;

FIG. 9 is an example plot illustrating a cloud of micro-seismic events distributed in a two-dimensional plane from a Barnett shale fracturing treatment, in accordance with embodiments of the present disclosure; and

FIG. 10 is a schematic diagram Illustrating an azimuthal angle definition projected on a horizontal plane, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first”, “second” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the data processing system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Similarly, as used herein, the term “substantially parallel” may be used to define downhole tools, formation layers, and so forth, that have longitudinal axes that are parallel with each other, only deviating from true parallel by a few degrees of each other. For example, a downhole tool that is substantially parallel with a formation layer may be a downhole tool that traverses the formation layer parallel to a boundary of the formation layer, only deviating from true parallel relative to the boundary of the formation layer by less than 5 degrees, less than 3 degrees, less than 2 degrees, less than 1 degree, or even less.

Various existing techniques of hydraulic fracture evaluation have been developed to estimate geometries of fractures (e.g., created by the hydraulic fracturing). For example, the existing techniques of hydraulic fracture evaluation may include an indirect evaluation based on an analysis of pressure responses measured during a treatment (e.g., a reservoir stimulation using a fluid injection) and/or a production when the fracture is bi-wing. This analysis may provide certain general information, such as fracture lengths, fracture conductivities, and fracture widths. However, such analysis may fail when a more complex fracture geometry is created by the stimulation treatment. Moreover, such analysis may suffer a lack of uniqueness, in the sense multiple differing geometries may lead to the same pressure response, and therefore may not provide useful information about the fracture geometry created from fluid injection. In some cases, a production analysis may provide information about an effective length and/or apparent conductivity of a fracture. However, such analysis may not provide details about an actual three-dimensional geometry of fracture conductivities and analytic results (e.g., predictions) may not be unique.

For another example, some techniques of hydraulic fracture evaluation may include using more reliable methods, such as acoustic fracture imaging methods based on events (e.g., micro-seismic events) locations using passive acoustic emissions. The passive acoustic emissions recorded during the hydraulic fracturing may include micro-earthquakes generated in a vicinity of the fracture and caused either by a stress change generated around the fracture or by a decrease of an effective stress around the fracture following fracturing fluid leak-off into the formation. In some cases, the events may be analyzed to provide information about source parameters (e.g., energy, displacement field, stress drop, source size) and/or source mechanisms. The events may be recorded by an array of geophones or accelerometers placed in adjacent boreholes (e.g., boreholes in two or more adjacent wells). The events may not provide direct quantitative information on main fractures. The acoustic fracture imaging methods based on events may be used to estimate fracture azimuth, dip and complexity. However, such methods may have certain limitations. For example, when micro-earthquakes occur around the fractures and create a cloud of micro-seismic events, these may be too large to allow an acceptable determination of fracture geometry using such methods.

As mentioned above, the existing techniques of may include using the estimated stimulation volume (ESV) for a production estimation with an assumption that the cloud of micro-seismic events represents a zone that is successfully stimulated and remains conductive once the fractures are closed. However, this assumption may be flawed when a stimulated volume does not match a conductive volume. Certain research studies indicate a two-order magnitude mismatch in term of created surface area because the conductive zone has a lower extent than a stimulated zone.

For yet another example, the existing techniques of hydraulic fracture evaluation may include tiltmeter mapping. This technique may include monitoring of a deformation pattern of rock surrounding an induced fracture network by using an array of tiltmeters that measure a gradient of a displacement (tilt) field versus time. An induced deformation field may be a function of fracture azimuth, dip, depth to a fracture middle point and a total fracture volume. A shape of the induced deformation field may be independent of reservoir mechanical properties if the rock is homogeneous. Surface tiltmeters may not accurately resolve the fracture length and height when a distance between the surface and the fracture is large compared to fracture dimensions. Downhole tiltmeters placed in a treatment borehole may provide better information on the fracture height but they may not resolve for the fracture length and the fracture conductivity. Therefore, tiltmeter mapping may have certain use in shallow reservoirs but may provide less information in deep reservoirs.

In certain cases, some techniques of hydraulic fracture evaluation may also include using refraction and transmission of waves through natural faults. These waves are either initiated from earthquakes or are produced by downhole seismic sources (e.g., active acoustic emissions). From the attenuation of these waves (e.g., due to fault crossing), one may estimate a fault effective shear and a normal stiffness. Similarly, tomography has been used in the laboratory to determine the position of the fracture from refraction and reflection data analysis whilst signal attenuation is used to estimate an effective fracture width. For example, one may use the attenuation of acoustic waves through a propped fracture to estimate the fracture width. The attenuation of the wave through the fracture allows one to determine the stiffness. Since the stiffness of a bed of proppant of a given width and under a given confining pressure is known from laboratory experiments, the obtained value of the stiffness determined from the wave attenuation is then inverted to estimate the fracture width (e.g., once closed or during closure). When the fracture is open, the stiffness is given by the fluid compressibility and fracture width. Note that this technique may also allow one to estimate whether the proppant is present or not at a given location since contrast of the stiffness is expected between a propped fracture and a non-propped fracture. The source of the event is preferably passive during the fracturing of the formation and closure of the fracture but may also be an active source.

Embodiments of the present disclosure provide systems and methods for utilizing an optimized seismic data processing based on cross-well seismic data to deliver insights and images of rock formations that may support an optimization of a fluid injection process (e.g., used in a hydraulic fracturing process). The techniques described herein may provide solutions, such as evaluating and estimating changes of rock formations using elastic waves (e.g., propagating at low frequencies in a seismic frequency range) to minimize signal attenuation (e.g., as the signals propagate through large distances as they are expected to probe in the rock formations).

Amongst various seismic configurations, cross-well seismic techniques may offer an attractive solution to address certain issues described above (e.g., estimating a production following the stimulation treatment in a complex reservoir where a fracture fairway is created). For example, the cross-well seismic techniques may enable estimations of rock mechanical properties (e.g., a velocity field associated with states of the rock formations at time when a cross-well seismic surveying is performed). A particular surveying may yield an imaging of an overall structure via data analysis of various reflectors being imaged. Analyzing data acquired from multiple surveys (e.g., conducted at separate times such as time-lapse cross-well seismic) may yield an estimation of changes occurred to the rock due to specific dynamical process such as hydraulic fracturing or fluid injection. The analytic result may provide insights on how to improve (e.g., optimize) an injection efficiency that may lower the cost of measurement while drilling (MWD) and/or logging while drilling (LWD) processes and facilitate geoscientists to make enhanced data driven decisions.

Techniques described in the present disclosure include the use of cross-well seismic to image reservoir structures illuminated with sources located in a well and receivers located in one or more nearby wells. The techniques include numerical algorithms and workflows using an inversion engine (e.g., including an elastic vertical transverse isotropy (VTI) anisotropic full waveform inversion (EFWI)) for data acquired with a cross-well seismic survey. For example, the EFWI may be based on a wave propagation modeling engine that may accurately account for physical phenomena of seismic waves propagating in subsurface formations, such as compressional waves (e.g., P-waves) and shear waves (e.g., S-waves including vertical SV waves and horizontal SH waves), direct waves, up-going and/or down-going waves, reflected waves, converted waves, multiple events, head waves, guided modes, and so on. The inversion engine may utilize all or a subset of these waves/events to yield 2D maps of the elastic properties, such as compressional and shear velocities, VTI anisotropy parameters, bulk density, attenuation, and so forth.

The methods described in the present disclosure may include modeling and inversion processes based on source and receiver mechanism, such as radiation patterns, spatial distribution, source wavelets, transfer functions, and so on. For instance, the numerical algorithms may accommodate a dual-force type of the source, geophone type receivers, as well as the data acquired with distributed acoustic sensing (DAS) measurements. The numerical algorithms in the present disclosure are illustrated through a formulation in 2D coordinates, providing 2D output of medium properties (e.g., 2D maps of elastic properties). Moreover, the numerical algorithms may be used to model a 3D point source and accommodate 3D deviations of an acquisition geometry. Furthermore, the numerical algorithms may include more general 3D formulations. The resulting 2D maps of elastic properties may be used for characterization of either physical or structural properties of the subsurface. The workflow described in the present disclosure may utilize various signal processing methods and specific seismic processing techniques, such as a travel time tomography in a pre-processing, a post-processing, an inversion workflow, and the like.

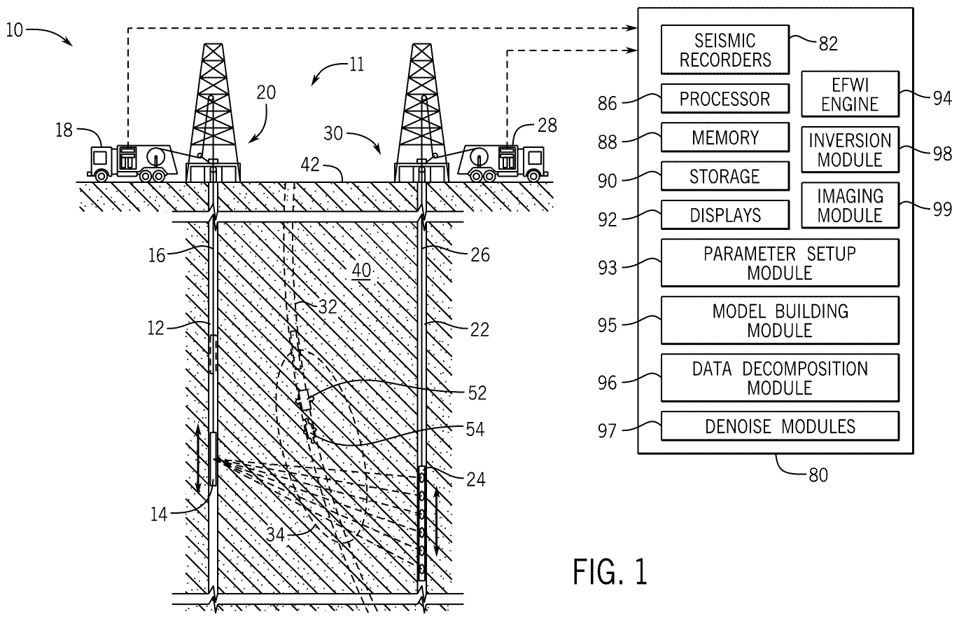

By way of introduction, FIG. 1 depicts a schematic diagram of a seismic survey 10 and a data processing system 80 using cross-well seismic data. The seismic survey 10 includes a configuration for tomographic imaging for a hydraulic fracture characterization using downhole seismic sources. The seismic survey 10 may include acquiring the cross-well seismic data using a seismic acquisition system 11 that includes the downhole seismic sources, additional seismic sources (e.g., seismic waves created during a perforation process), various seismic receivers (e.g., downhole seismic sensors, surface seismic sensors), recording devices, and other equipment (e.g., seismic trucks loaded with surface seismic sources). and the data processing system 80 may process the cross-well seismic data to generate output indicative of characterizations of physical and/or structural properties of the subsurface. For instance, the output may include a high resolution time-lapse image of a stress field created by a hydraulic fracture stimulation in a reservoir (e.g., an oil or natural gas reservoir). In one embodiment, a residual stress imaged post fracture stimulation may be equivalent or close to an area of the reservoir that may remain actively supported by a proppant placed during the hydraulic fracture stimulation.

In the illustrated embodiment, three adjacent wells, including a source well 12, a monitoring well 22, and a treatment well 32, penetrate a subterranean formation 40. The source well 12 may be used for deploying one or more downhole seismic sources, when activated, generating seismic waves seismic waves propagating through the subsurface (e.g., the subterranean formation 40). The monitoring well 22 may be used for deploying one or more downhole seismic receivers or a downhole seismic receiver array to detect the seismic waves arriving at the monitoring well 22. The well 32 may be used for hydraulic fracture stimulations.

Two-dimensional (2D) and/or three-dimensional (3D) imaging of the subsurface (e.g., the subterranean formation 40) may be obtained by first acquiring baseline cross-well seismic tomographic velocity images and/or attenuation images. The baseline cross-well seismic tomographic velocity images may indicate a seismic wave (e.g., P-waves, S-waves, converted waves) velocity distribution in the subterranean formation 40. The attenuation images may indicate attenuations associated the seismic waves propagating through the subterranean formation 40. The acquired baseline cross- well seismic tomographic velocity images and/or the attenuation images may be used for tomographic imaging of hydraulic fracture characterizations.

The seismic survey 10 may include a borehole-to-surface arrangement for tomographic imaging of hydraulic fracture characterizations. For example, the tomographic imaging may include obtaining 2D/3D images indicating shapes, structures, and other relevant information (e.g., fractures) regarding the subterranean formation 40. The 2D/3D images may be obtained by acquiring a first baseline cross-well seismic tomographic velocity image and/or an attenuation image prior to the hydraulic fracture stimulation treatment via the treatment well 32. Upon a completion of the hydraulic fracture stimulation treatment, a second seismic tomographic velocity and/or attenuation image may be acquired.

In one embodiment, the 2D or 3D images may be obtained by deploying a downhole seismic source 14 in the source well 12 via a wireline 16 and a truck 18 at a wellhead 20 on a surface 42. The downhole seismic source 14 may include a device that generates controlled seismic energy, such as a seismic vibrator, a thumper, a dual-force type of source, and so on. When activated, the downhole seismic source 14 may generate seismic waves propagating through the subsurface including an area 34 (e.g., an area of interest associated with the subterranean formation 40) in a vicinity of the treatment well 32. The downhole seismic source 14 may move along the source well 12 so as to provide adequate coverage of the area 34.

A downhole seismic receiver array 24 may be deployed in the monitoring well 22 via a wireline 26 and a truck 28 at a wellhead 30 on the surface 42. The downhole seismic receiver array 24 may record seismic events (e.g., reflections, refractions) created by the seismic waves initiated by the downhole seismic source 14. The downhole seismic receiver array 24 may include geophones, accelerometers, hydrophones, fiber-optic sensors (e.g., distributed acoustic sensing (DAS) sensors), and so on. The downhole seismic receiver array 24 may move along the monitoring well 22 so as to provide adequate coverage of the area 34.

Although the seismic acquisition system 11 shown in FIG. 1 includes the downhole seismic source 14, the downhole seismic receiver array 24, the trucks 18 and 28, according to some embodiments, the seismic acquisition system 11 may include additional equipment and/or devices, such as additional seismic sources (e.g., seismic waves created during a perforation process), perforation equipment 52 and stimulation equipment 54 (e.g., equipment for perforating and stimulating the well 32 to create fractures in the area 34), additional seismic receivers (e.g., surface seismic sensors), recording devices, and so on. For instance, the perforation equipment 52 may be deployed in the subterranean formation 40 to perforate the well 32 and generate seismic waves propagating through a fractured area in the subterranean formation 40.

Although the downhole seismic source 14 and the seismic receiver array 24 are shown in FIG. 1 as being deployed in respective wells, according to some embodiments, the downhole seismic source 14 or the seismic receiver array 24 may be deployed on the surface 42. In one embodiment, the downhole seismic source 14 may be deployed in the treatment well 32 while a surface seismic receiver array (e.g., similar to or different from the seismic receiver array 24) may be deployed on the surface 42 in a vicinity of the monitoring well 22, for example. In one embodiment, the seismic receiver array 24 may be deployed in the monitoring well 22 while a surface seismic source may be deployed on the surface 42. In such cases, a movability of the downhole seismic source 14 or the seismic receiver array 24, as described previously, may provide adequate coverage of the area 34. Additionally, a movability of the surface source (e.g., a seismic vibrator truck) or the surface seismic receiver array may provide adequate coverage of the area 34.

Although the surface 42 is shown in FIG. 1 as being a land surface, according to some embodiments, a region above the surface 42 may be water as in a case of marine applications. In one embodiment, the surface 42 is a sea floor and the downhole seismic source 14 and the seismic receiver array 24 may be deployed in wells drilled at the sea floor. In such embodiment, certain example equipment, such as the trucks 18 and 28, may be replaced by seismic vessels, for example.

In one embodiment, a seismic data acquisition for obtaining the 2D/3D images may be initiated by activating the downhole seismic source 14 to transmit high bandwidth seismic waves (e.g. 30 Hz to 800 Hz) to the downhole seismic receiver array 24, which may detect arrived seismic waves and generate cross-well seismic data. Next, the downhole seismic source 14 may be moved up/down (e.g., via the wireline 16) along a wellbore of the source well 12 and activated again to initiate a new round of data acquisition, including moving up/down (e.g., via the wireline 26) the downhole seismic receiver array 24 along a borehole of the monitoring well 22 by a distance (e.g., a length of the downhole seismic receiver array 24). The downhole seismic source 14 may be activated again to transmit seismic waves to the downhole seismic receiver array 24. Such data acquisition may be replicated until all areas of interest (e.g., including the area 34) are covered vertically, allowing the cross-well seismic data to be fully acquired and collected between the source well 12 and the monitoring well 22 and directly across a reservoir or other zones of interest that may be associated with the subterranean formation 40.

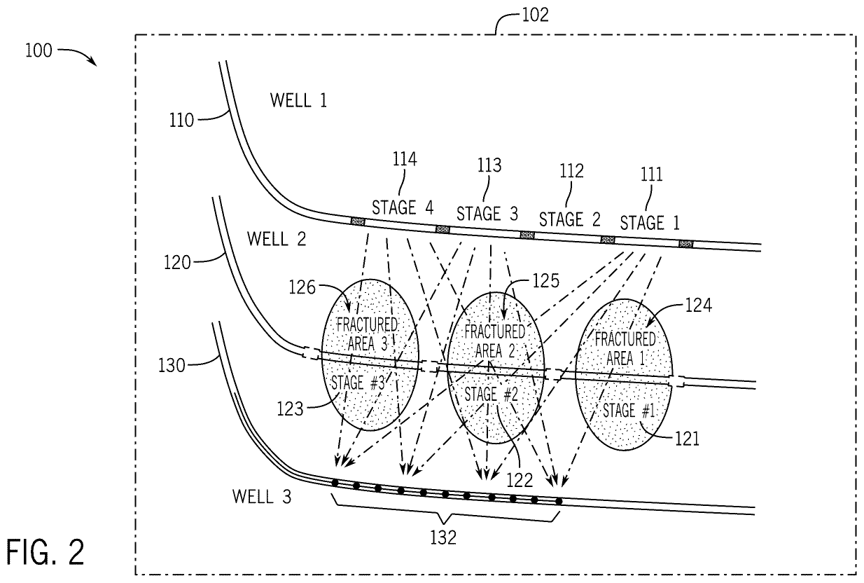

In one embodiment, an expected stimulation zone may include the area 34 in a vicinity of the treatment well 32. A hydraulic fracture stimulation treatment of the reservoir may include injecting, via the treatment well 32, a high viscosity fracturing fluid at a high flow rate to open and then propagate tensile fractures in the subterranean formation 40. The high viscosity fracturing fluid may contain proppants including small particles (e.g., sand grains or ceramic grains) added to the fluid to maintain a fracture opening once a fluid pumping is completed and pressure is released. The hydraulic fracturing may create a high conductivity drain in the subterranean formation 40. The production of the hydrocarbons may occur through the proppant packed fractures. Additional details related to the hydraulic fracture stimulation treatment will be described below with reference to FIG. 2, for example.

Although the source well 12, the monitoring well 22, and the treatment well 32 are shown in FIG. 1 as vertical (or close to vertical), according to some embodiments, these wells may include lateral wells that may include a vertical portion (e.g., starting from a wellhead) followed by a curved portion (e.g., starting from the end of the vertical portion), which may be followed by a horizonal portion. Additional details related to the lateral wells will be described below with reference to FIG. 2, for example.

Although the seismic source is shown in FIG. 1 as a device (e.g., the downhole seismic source 14 such as a vibrator or a thumper) placed in a vertical well (e.g., the source well 12) generating controlled seismic energy, according to some embodiments, the seismic source may be created by certain controllable processes (e.g., a perforation process, a stimulation process) along a lateral well (e.g., at a horizontal portion, a vertical portion, or both) that may generate seismic energy as well. In such embodiments, monitoring devices (e.g., devices similar to the downhole seismic receiver array 24) placed along an adjacent lateral well (e.g., at a horizontal portion, a vertical portion, or both) may detect seismic events (e.g., micro-seismic events) induced by the seismic energy generated by the controllable processes. Additional details related to the perforation process, the stimulation process, the micro-seismic events, will be described below with reference to FIG. 2, for example.

The cross-well seismic data acquired in the seismic survey 10 may be collected and processed by the data processing system 80. The data processing system 80 may include one or more seismic recorders 82, one or more processors 86, a memory 88, a storage 90, one or more displays 92, and an inversion engine such as an elastic full waveform inversion (EFWI) engine 94. The one or more seismic recorders 82 may receive seismic data acquired by the downhole seismic receiver array 24 and other receivers (e.g., surface receivers). Collected data may be processed by the processor 86 using processor-executable code or instructions stored in the memory 88 and the storage 90. The processed data may be stored in the storage 90 for later usage. The results of the processed data may be displayed via the one or more displays 92.

In an embodiment, the memory 88 and/or the storage 90 may store instructions that, when executed by the one or more processors 86, cause the one or more processors 86 to implement the elastic full waveform inversion (EFWI) engine 94. In an embodiment, the elastic full waveform inversion (EFWI) engine 94 may run on a separate hardware component (e.g., a processing circuitry) communicatively coupled to the one or more processors 86.

Additionally, the data processing system 80 may include a parameter setup module 93 configured to define and initialize a set of processing parameters and a set of geological parameters associated with the subsurface formation in area 34; a model building module 95 configured to construct an initial subsurface model indicative of the set of geological parameters; a data decomposition module 96 configured to decompose at least a portion of the cross-well seismic data into inline and crossline components based on the set of processing parameters; multiple denoise modules 97 configured to reduce seismic noises contaminations in the inline and crossline components based on the set of processing parameters; an inversion module 98 configured to perform an elastic full waveform inversion to generate a final subsurface model based on denoised inline and crossline components and the set of processing parameters, wherein the elastic full waveform inversion inverts the set of parameters to update the initial subsurface model; and an imaging module 99 configured to perform a tomographic imaging of hydraulic fracture characterizations based on the final subsurface model to generate two-dimensional and/or three-dimensional images associated with the fractured area.

The processors 86 may include any type of computer processor or microprocessor to execute computer-executable code. The processors 86 may include single-threaded processor(s), multi-threaded processor(s), or both. The processors 86 may also include hardware-based processor(s) each including one or more cores. The processors 86 may include general purpose processor(s), special purpose processor(s), or both. The processors 86 may be communicatively coupled to other components (such as one or more seismic recorders 82, interrogator 84, memory 88, storage 90, and one or more displays 92).

The memory 88 and the storage 90 may be any suitable articles of manufacture that can serve as media to store processor-executable code, data, or the like. For example, the memory 88 and the storage 90 may represent non-transitory computer-readable media (e.g., any suitable form of memory or storage) that may store the processor-executable code used by the processor 86 to perform the presently disclosed techniques. It should be noted that non-transitory merely indicates that the media is tangible and not a signal. The memory 88 and the storage 90 may also be used to store data described (e.g., fiber sensor data, geophone data), various other software applications for seismic data analysis and data processing.

The one or more displays 92 may operate to depict visualizations associated with software or executable code being processed by the processor 86. The display 66 may be any suitable type of display, such as a liquid crystal display (LCD), plasma display, or an organic light emitting diode (OLED) display.

The EFWI engine 94 may utilize the cross-well seismic data to image reservoir structures in the subterranean formation 40 that are illuminated with the seismic waves from the downhole seismic source 14 activated in the source well 12. The downhole seismic receiver array 24 deployed in the monitoring well 22 may detect arrived seismic waves and generate the cross-well seismic data. The EFWI engine 94 may include various numerical algorithms and workflows. For example, the EFWI engine 94 may include an elastic vertical transverse isotropy (VTI) anisotropic FWI algorithm based on wave propagation modeling (e.g., finite element modeling) that may account for various physical phenomena (e.g., seismic waves or events) associated with seismic waves propagating in subsurface, such as P-waves, S-waves, direct waves, up-going and/or down-going waves, reflected waves, refracted waves, converted waves, multiple events, head waves, guided modes, and so on. The EFWI engine 94 may utilize at least a portion of the seismic waves or events to generate two-dimensional (2D) maps indicative of various elastic properties, such as compressional and shear velocities, VTI anisotropy parameters, bulk density, attenuation, and so forth.

In one embodiment, the data processing system 80 may be implemented in an on-site data center near an area in which the seismic survey 10 is conducted. In another embodiment, the data processing system 80 may be implemented in an offsite data center and/or using cloud computing resources (e.g., via a network) away from the area in which the seismic survey 10 is conducted.

The components described above with regard to the data processing system 80 are exemplary components and the data processing system 80 may include additional or fewer components as shown. For example, the data processing system 80 may include one or more communication interfaces to send commands to different seismic acquisition systems and receive measurement from the different seismic acquisition systems.

With the preceding in mind, material related to the technologies and terms, such as tomographic imaging of hydraulic fracture characterizations, is provided below to impart some familiarity with the seismic survey 10 and the data processing system 80 described above, and provide useful real-world context for other aspects of the present disclosure.

Tomography (e.g., tomographic seismic velocity model building and imaging) may include a variety of methods. For example, certain methods may utilize variations of a P-wave velocity, or a S-wave velocity, or both because it is expected that a zone (e.g., a stimulation zone) being fractured may have a velocity decrease. An analysis of wave refractions may be used as an indicator to map hydraulic fractures. However, other measurement attributes (e.g., attenuations of seismic waves) may be more sensitive than the wave refractions.

Certain methods may use an assumption that a velocity field for mapping a reservoir is not sensitive to stress changes and a presence of induced fractures. Such assumption may enable using micro-seismic events (e.g., triggered by the induced fractures during the hydraulic fracture stimulation treatment) in a process of tomography, which may include locating the micro-seismic events and determining signal attenuations acquired at various sensors.

In some cases, a high attenuation may be interpreted as related to a fracture width. In some cases, a wide-open section may not be crossed by S-waves because S-waves may not propagate in fluids. In some cases, the S-waves may cross a fluid-filled section through evanescence albeit with a significantly attenuated and non-detectable amplitude. Differently, P-waves may cross such sections (e.g., fluids or fluid-filled sections) with an attenuation to an extent that may be detectable and/or interpreted (e.g., based on a change of stiffness between a matrix and the fracture).

With these in mind, FIG. 2 is an example of a cross-well seismic configuration 100 used to image a hydraulically fractured zone. Three lateral wells, including a well 110, a well 120, and a well 130, are drilled in an area 102 including the hydraulically fractured zone. The well 130 may include a monitoring tool 132 that records micro-seismic events, as well as any other events rising from excitations of seismic waves (e.g., seismic waves induced by perforating well casing for the purpose of injections of a fracturing fluid). The monitoring tool 132 may include multiple seismic receivers (sensors) or a receiver array (e.g., the downhole seismic receiver array 24). In the illustrated embodiment, the monitoring tool 132 includes 11 shuttles separated by a distance (e.g., about 100 feet). Each shuttle may include one or more seismic receivers (e.g., 3-component (3C) geophones).

Prior to fracturing the well 120, an initial subsurface model is constructed using an EFWI workflow (e.g., using the EFWI engine 94). For example, the subsurface model may include parameter values indicative of elastic properties (e.g., seismic velocities, seismic attenuations) associated with a subsurface formation in the area 102. The EFWI workflow may produce elastic property information from seismic volumes tied to seismic events measured in one or more wells (e.g., wells drilled in the area 102) through borehole sonic logging measurements (e.g., P-wave and S-wave velocity logs). The EFWI workflow may also produce calibrated 2D/3D velocity volumes and 2D/3D volumes of seismic anisotropy parameters tied to analogous parameters estimated from borehole sonic logging measurements. The velocity model may be indicative of a velocity distribution (e.g., P-wave velocity, S-wave velocity) of the formation in the area 102 that includes the production zone.

The cross-well seismic configuration 100 may be used in a multi-stage hydraulic fracturing treatment as illustrated in FIG. 2. The multi-stage hydraulic fracturing treatments may include multiple processing blocks associated with multiple stages of the well 120. Each stage may be perforated via a perforation process at a time, followed by a stimulation process. The perforation process establishes flow paths between a reservoir and a wellbore. For example, the perforation process may include initiating holes from the wellbore through well casing and a cement sheath into a producing zone in the reservoir.

The stimulation process may include an injection of a fracturing fluid, which is a process of pumping the fracturing fluid into the wellbore and then to the formation (that includes the production zone) via the flow paths established in the perforation process. During the fracturing fluid injection, the fracturing fluid is pumped at an injection rate that is too high for the formation to accept without breaking down. As such, a resistance to flow in the formation increases and a pressure in the wellbore increases to a value (so called a break-down pressure). At this break-down pressure, the formation break downs, resulting in fractures (or hydraulic fractures) that allow the injected fluid to flow through it.

The fracturing fluid may contain proppants (e.g., small particles such as sand grains or ceramic grains) to maintain a fracture opening once the pumping is stopped and pressure is released. At the end of the stimulation process, the fractures packed with the proppants are created, allowing reservoir fluids (e.g., hydrocarbons) flow through the proppant packed fractures.

The example of FIG. 2 may illustrate the multi-stage hydraulic fracturing treatment. In a first processing step, a first stage 121 of the well 120 is perforated via the perforation process. The monitoring tool 132 deployed in the well 130 registers seismic waves (e.g., perforation events) generated by the perforation process conducted in the first stage 121. The monitoring tool 132 obtains a calibration point using registered perforation events. Based on the calibration point, the monitoring tool 132 constructs an updated velocity map or an updated attenuation map.

After the perforation process, the stimulation process (e.g., a hydraulic fracture stimulation treatment) starts in the first stage 121 of the well 120, resulting in induced micro-seismic events that is recorded by the monitoring tool 132. After the stimulation process is completed, the first stage 121 is isolated using equipment such as a first packer. In certain cases, data collected during the perforation process (e.g., registered perforation events) may be used to design an optimized fracture-stimulation treatment. For example, the registered perforation events may be used to adjust one more stimulation parameters (e.g., reduced proppant usage) to optimize the fracture-stimulation treatment.

In a second processing step, the similar processes described above (e.g., the perforation process, registration of the perforation events, the stimulation processes) starts with a second stage 122 of the well 120. The perforation of the second stage 122 results in an updated calibration step based on the perforation events generated by the perforation process conducted in the second stage 122. After the perforation process, the stimulation process starts in the second stage 122 of the well 120, resulting in different induced micro-seismic events that is recorded by the monitoring tool 132. After the stimulation process is completed, the second stage 122 is isolated using equipment such as a second packer.

In a third processing step, the similar process starts with a third stage 123 of the well 120. The perforation of the third stage 123 results in another updated calibration step based on the perforation events generated by the perforation process conducted in the third stage 123. After the perforation process, the stimulation process starts in the third stage 123 of the well 120, resulting in different induced micro-seismic events that is recorded by the monitoring tool 132. After the stimulation process is completed, the third stage 123 is isolated using equipment such as a third packer.

At the end of the third processing step, the three stages of well 120, including the stages 121, 122, and 123 are fractured, as shown in FIG. 2, resulting in three fractured areas 124, 125, and 126, respectively. Each of the three fractured areas 124, 125, and 126 includes respective fractures (e.g., bi-wing tensile fractures) in the formation that includes the production zone. The lengths of the fractures may attain, for example, up to several hundred meters. The fractures may form an induced fracture network. A computing system (e.g., the data processing system 80) may determine a stimulated volume through leveraging of all the induced micro-seismic event locations, for example.

The similar processes described above, such as the perforation process, registration of the perforation events, and the stimulation processes, may continue with the well 110, as show in FIG. 2. Additionally, certain different processes may be used in fracturing the well 110. For instance, each time a new stage (e.g., stage 111, 112, 113, or 114 is fractured in the well 110, seismic waves (e.g., perforation events) created by the perforation process may propagate through one or more previously fractured areas (e.g., the fractured areas 124, 125, and 126). Such perforation events may be used as seismic sources to probe the previously fractured areas, resulting in new formation information (e.g., geometric information of the induced fracture network).

In one embodiment, as perforation events propagating through the previously fractured areas, the computing system may gather ample data to perform further data analysis, such as a new seismic velocity analysis, a new seismic attenuation analysis, and so on. The computing system may determine an area that is most influenced by the induced fracture network. The computing system may estimate an amount of changes between the tomographic result (e.g., velocity maps or attenuation maps) before and after the fracturing treatment. Such changes may be related to fractured volumes being created during the stimulation process, allowing the computing system to generate new analytic data, such as a spatial indicator of fracture conductivity.

The methods described above may be updated (e.g., using additional data) to improve accuracies of different determinations (e.g., determining the stimulated volume, the most influenced area, the amount of changes, or the spatial indicator). In one embodiment, the additional data may include borehole sonic logging measurement that may be run after the hydraulic fracturing process in the well 120 to determine the velocity and attenuation changes along a lateral direction (e.g., along the borehole of the well 120). In one embodiment, the additional data may include additional measurement acquired by seismic receivers in a horizontal, section, a vertical section, or both, from one or more additional monitoring wells (e.g., other than the well 130).

In one embodiment, the additional data may include additional measurement acquired by a monitoring tool (e.g., downhole seismic receiver array 24) being moved during the hydraulic fracturing process within the monitoring well (e.g., the well 130), or being moved from one well (e.g., the well 130) to another one (e.g., one of the additional monitoring well). In one embodiment, the additional data may include measurement in response to seismic waves generated by one or more calibrated downhole seismic sources capable of moving long a source well.

In one embodiment, the additional data may include P-wave and converted wave (P-wave converted to S-wave, or PS-wave) data from a surface seismic survey. For example, the computing system may process these waves with azimuthal information to estimate fracture orientations, fracture densities, fracture-fluid contents, and so on. Depending on data quality (e.g., signal to noise ratios (SNRs), the computing system may provide an independent quantitative estimation of fluid-filled fractures (e.g., fluid-filled fracture map) before and after a fracturing process.

In one embodiment, the computing system may use the micro-seismic events (e.g., induced micro-seismic events recorded by the monitoring tool 132) to improve accuracies of certain determinations describe above, and/or to improve efficiencies of such determinations, such as in cases where the seismic velocity field may be less affected by the fractured area in comparison to but the seismic attenuation.

With the additional data described above, the computing system may generate new analytic data, such as the fluid-filled fracture map, an updated velocity map, an updated attenuation map, a map based on different seismic wave attributes (e.g., amplitudes, phases, polarizations), and so on. Using the new analytic data, the computing system may perform an overall analysis, resulting in a determination of part of the conductive part of the estimated stimulation volume (ESV) for a production estimation, and a realistic stimulated volume, therefore enabling users (e.g., geophysicists and geologists) to switch a domain of interest (e.g., an interpretation in terms of ESV) to another domain of interest (e.g., an interpretation in terms of a reservoir stimulation volume (RSV)).

In certain embodiments where downhole seismic sources are used in adjacent lateral wells, the new analytic data (including various maps) may be derived as a function of time (e.g., time-lapsed data). For example, the computing system may construct a map during a fracturing treatment and another map after the fracturing treatment, for example, after a few hours, a few days, a few months, and the like. With comparisons between these maps constructed at different times, the computing system may determine whether a proppant embedment and/or a fracture clean-up occurred.

Although the methods are described in FIG. 2 as being related to the hydraulic fracturing and monitoring using adjacent lateral wells (e.g., wells 110, 120, and 130), according to some embodiments, such methods may be applicable to other fluid injection processes, such as CO2 storage, geothermal applications, and the like. In such processes, perforations using injection tubing may provide means to calibrate velocity models while micro-seismicity induced from fluid injections under pressure may be leveraged to image the expansion of the CO2 pressure or plume volumes. In this sense, the methods described in present disclosures may have a wide applicability across various domains of fluid injections in the subsurface.

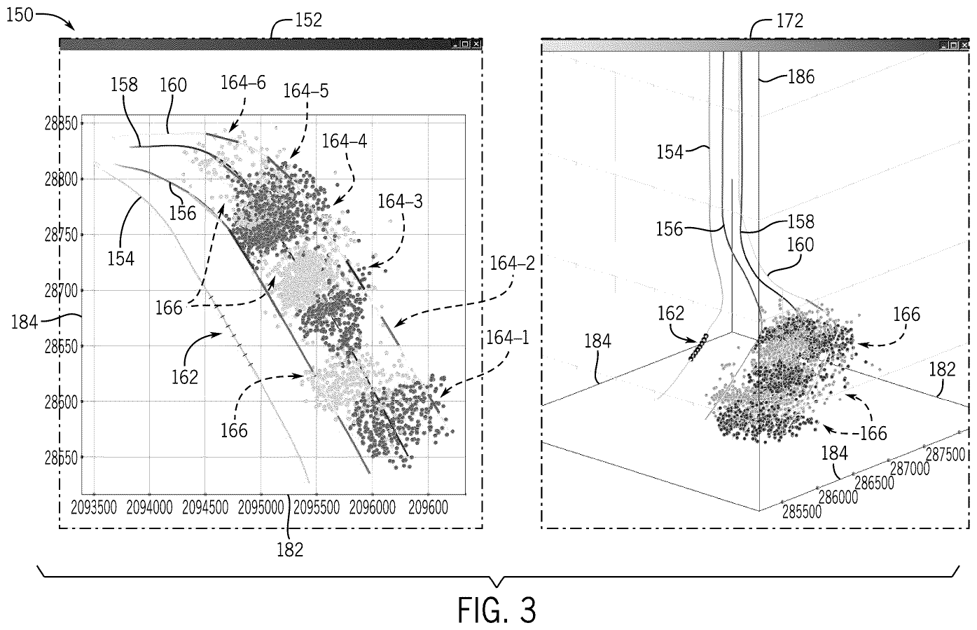

FIG. 3 is an example of a seismic field survey 150 using the cross-well seismic configuration 100 of FIG. 2 and results from a multi-stage hydraulic fracturing treatment. A plot 152 is a top view of the seismic field survey 150 in a horizontal plane along an axis 182 (representing an East-to-West direction) and an axis 184 (representing a North-to-South direction). The seismic field survey 150 includes four lateral wells 154, 156, 158, and 160. Among these wells, the lateral well 154 is a monitoring well with a monitoring tool 162 (e.g., similar to the monitoring tool 132) detecting and recording seismic waves generated from adjacent wells, such as wells 156, 158, and 160, during the multi-stage hydraulic fracturing treatment.

The multi-stage hydraulic fracturing treatment may include multiple processing steps associated with multiple stages of each of the wells 156, 158, and 160. Each stage may be perforated via a perforation process at a time, followed by a stimulation process. For example, the multi-stage hydraulic fracturing treatment may start with the lateral well 158. In a first processing step, a first stage of the lateral well 158 is perforated via the perforation process. The monitoring tool 162 deployed in the lateral well 154 registers seismic waves (e.g., perforation events) generated by the perforation process conducted in the first stage of the lateral well 158.

After the perforation process, the stimulation process (e.g., a hydraulic fracture stimulation treatment) starts in the first stage of the lateral well 158, resulting in induced micro-seismic events that is recorded by the monitoring tool 162. After the stimulation process is completed, the first stage is isolated using equipment such as a packer. Next, the similar process starts with a second stage of the lateral well 158, followed by a third stage, a fourth stage, and so on. After the perforation and stimulation processes are completed in each stage, the respective stage of the lateral well 158 is isolated using the equipment such as a respective packer.

At the end of the last processing step, all the stages of the lateral well 158 are fractured, resulting in fractures (e.g., bi-wing tensile fractures) in a fractured area of the seismic field survey 150 that may include a production zone. The lengths of the fractures may attain, for example, up to several hundred meters. The fractures may form an induced fracture network. A computing system (e.g., the data processing system 80) may determine a stimulated volume through leveraging of all the induced micro-seismic event locations.

The similar processes (e.g., the perforation process, the stimulation processes) may continue with the lateral wells 156 and 160, as show in FIG. 3. As described previously, additional processes may be used in fracturing the lateral wells 156 and 160. For instance, each time a new stage (e.g., stage 164-1, 164-2, 164-3, 164-4, 164-5, or 164-6) in the lateral well 160 is fractured, seismic waves (e.g., perforation events) created by the perforation process may propagate through the previously fractured area (e.g., the fractured area during the hydraulic fracturing treatment in the lateral well 158). Such perforation events may be used as seismic sources to probe the previously fractured area, resulting in new formation information (e.g., geometric information of the induced fracture network).

At the end of the multi-stage hydraulic fracturing treatment, numerous fractures (or microscopic fractures) are created and expressed as dots 166 shown in the plot 152. The dots 166 illustrate a spatial (a two-dimensional (2D) fracturing point distribution of the induced fracture network in the horizontal plane along axes 182 and 184.

For further illustration of the induced fracture network, a plot 172 is presented as a three-dimensional (3D) view of the seismic field survey 150 in a 3D space defined by the axes 182 and 184 and an axis 186 (representing depth).

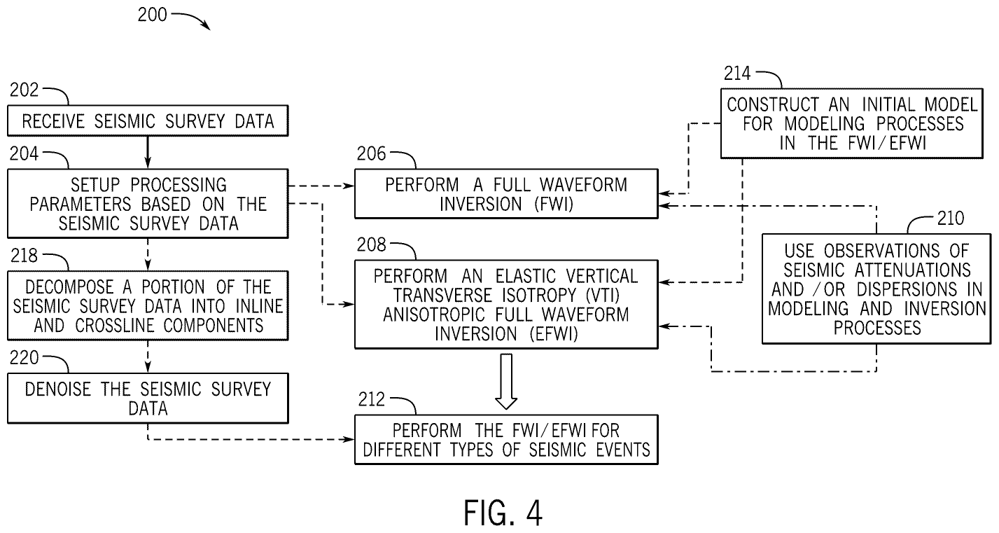

As mentioned above, a computing system, such as the data processing system 80, may use one or more processors (e.g., processor 86) to collect, analyze, and interpret seismic survey data acquired from one or more seismic surveys (e.g., seismic survey 10, sonic log survey, vertical seismic profile (VSP) survey) conducted in areas, where the hydraulic fracturing treatments are used. The data processing may include a processing scheme based on one or more workflows using various seismic data processing tools and algorithms (e.g., tomography, FWI, anisotropy), equations, models, and so on. Based on processing results, the computing system may generate various outputs, such as seismic velocity maps, seismic attenuation maps, anisotropic parameters, geometric information of the induced fractures and resulting induced fracture network, fracture conductivity, and so forth. Additional details related to the data processing will be described below with reference to FIGS. 4-10.

It should be noted that the processing scheme described herein is not intended to provide workflows in particular orders. For example, process blocks in the processing scheme described below may be performed by the computing system in any suitable orders, in any suitable combinations, or any suitable times.

Referring now to FIG. 4, a first block diagram 200 of the processing scheme that may be used in a processing system (e.g., the data processing system 80). The computing system may receive the seismic survey data acquired from the one or more seismic surveys (at process block 202). The seismic survey data may include cross-well data, other seismic data (e.g., seismic and/or micro-seismic events detected by one or more adjacent wells other than the motoring well 130), time-lapsed data (e.g., constructed velocity and/or attenuation maps before, during, and after a fracturing treatment), well log data (e.g., sonic logs), VSP data, acquisition data (e.g., data related to one or more data acquisitions associated with the one or more seismic surveys, such as survey geometries, source and receiver locations, types, frequency profiles), and so on.

The computing system may setup processing parameters based on the seismic survey data (at process block 204). The computing system may use a parameter setup module to define and initialize the processing parameters. The initial setup may include determining certain processing parameters. For example, in cross-swell seismic survey (e.g., the seismic survey 10 as describe in FIGS. 1 and 2), seismic wavefields initiated at multiple sources deployed in a first well (e.g., the well 110) and detected by multiple receivers in a second well (e.g., the well 130) illuminate an area between the two wells. In some cases, due to a source-receiver acquisition geometry, the seismic wavefields may not provide illuminations of an entire 3D space medium (e.g., a formation) corresponding to the area. In a subsequent inversion process, the computing system may target resolution of either a two-dimensional (2D) vertical plane chosen as a representative of an acquisition plane, or a one-dimensional (1D) distribution of medium properties (e.g., rock formation properties) for the entire or a partial space of the medium in cases where the data acquisition is highly out-of-plane and a 2D illumination is not provided.

The computing system may also use the parameter setup module to define and initialize geological parameters associated with the subsurface formation in the area 102. For example, the geological parameters may be indicative of elastic properties of the subsurface formation, such as compressional wave velocity, shear wave velocity, VTI anisotropy parameters, bulk density, attenuation, and so on.

The computing system may perform a full waveform inversion (FWI) based on the seismic survey data (at process block 206). The FWI may be constructed as a minimization of a misfit between the field data (e.g., seismic data acquired in the one or more seismic surveys) and synthetic data (e.g., numerically computed seismic wavefields using various simulation models and algorithms). The misfit may be measured in a certain norm (or criterion). For example, the misfit may incorporate full waveforms or a portion of the full waveforms (e.g., a portion of events). The norm may include, but may not be limited to least squares, L1/Lp norm, optimal transport, envelope, reflection FWI formulation, and so on. In one embodiment, synthetic wavefields may be generated by modeling wave propagation equations. The FWI is an iterative procedure including multiple iterations. At each iteration, a simulation model may be updated and then used to computing new synthetic wavefields. The iteration process continues until the misfit reaches a threshold value, resulting in a fit (or matching) between the field data and the synthetic data. The iteration process may start with an initial model. The FWI may use a gradient based optimization procedure with gradients computed by an adjoint method. Certain prior information and constrains may be incorporated into the FWI through data or model covariance matrices, regularization terms, inversion reparameterization, and so on.

The computing system may perform an elastic vertical transverse isotropy (VTI) anisotropic full waveform inversion (EFWI) based on the seismic survey data (e.g., at process block 208). Via the EFWI, the computing system may update the initial model (e.g., by inverting the geological parameters) and generate a final model. For example, shear wave (S-wave) events may be observed in borehole seismic data and treated accurately in a modeling and an inversion process. Certain numerical experiments (e.g., simulation-based evaluations/validations) show that, if the shear wave events are neglected and/or a shear velocity model is not updated, the results of the inversion may be undesired. In some cases, anisotropy effects may be included in the modeling and/or inversion processes. In some cases, where near horizontal wave propagations (e.g., as a part of cross-well measurements), additional physical phenomena, such as guided modes, head waves, complex waves shapes, may be observed and included. Advanced modeling and inversion tools may be used to process such physical phenomena.

In one embodiment, a modeling engine may be designed by numerically solving elastic wave equations in anisotropic medium. Inverted parameters (e.g., medium parameters) after the EFWI may include a discretized spatial distribution of the medium parameters, such as compressional and shear wave velocities, bulk density, anisotropy, stiffness tensor, impedances, or reparameterization of these properties (e.g., components of the stiffness tensor, impedances). The EFWI may update all or a portion of the medium parameters simultaneously. In one embodiment, EFWI algorithms for processing the cross-well data may be extended to VSP data or combined with VSP data as well. For example, the EFWI may include a joint inversion using the cross-well data and the VSP data. Alternatively, in one embodiment, the EFWI may include a joint invention using surface seismic data and the VSP data.

In some cases, the computing system may use observations of seismic attenuations and/or dispersions (at process block 210). The computing system may use the observed seismic attenuations and/or dispersions in the modeling and inversion processes, or in the modeling process but not invert for attenuation/dispersion parameters, or compensate for attenuation and/or dispersion effects in the seismic survey data but not model and invert for the attenuation/dispersion parameters.

In some cases, the computing system may perform the EFWI for different types of seismic events (at block 212), such as compressional waves (P-waves), vertical shear waves (SV-waves), horizontal shear waves (SH-waves), converted waves (SP-waves), other seismic events (e.g., head waves, guided modes, interface waves, near field terms).

The computing system may construct an initial model for the modeling processes in the FWI and EFWI (at process block 214). For example, the computing system may use a model building module to construct the initial model. The initial model construction may be based one or more options of the geological parameters that depends on the availability of certain data in the seismic survey data. Such options may include smoothed P-wave, S-wave, and density logs for the source and/or receivers wells and/or nearby wells, tomography for first arrivals for P-waves and/or SH-wave direct events, estimation of one of the medium properties (e.g., S-wave velocity or density) with empirical relations from other medium properties (e.g., P-wave velocity or density), models available from surface seismic or VSP data processing, and so on. The initial model may be isotropic or anisotropic.

The computing system may use a data decomposition module to decompose a portion of the seismic survey data into inline and crossline components of the wavefields recorded (at process block 218). For example, an inline direction may be defined as a horizontal direction from a seismic source to a seismic receiver, and a crossline direction may be defined as a horizontal direction perpendicular to the inline direction. An Inline plane is a vertical plane including the inline direction, and a crossline plane is a vertical plane including the crossline direction. The inline plane may be different from a 2D acquisition plane because the sources and receivers may not locate at the same plane.

The FWI/EFWI algorithms may be formulated for the inline and crossline components of the wavefields recorded. The inline components may correspond to the wavefields that is polarized in the inline plane, and the crossline component may correspond to the wavefields that is polarized in the crossline plane.

Various seismic noise attenuation methods may be performed (at process block 220) to reduce variety noises presented in the seismic survey data. For example, the computing system may use one or more denoise modules to reduce seismic noises contaminations in the inline and crossline components based on the processing parameters. The seismic noise attenuation methods may include random noise attenuations and coherent noise attenuations. The noises may include random noise and coherent noise, such as ground roll noise, seismic interference noise, passing vehicle noise, vertical particle velocity noise, spike-like noise, cross-feed noise, receiver noise, and so on. The computing system may utilize these methods (e.g., in different combinations) to reduce noise contamination in the seismic survey data, resulting in relatively less noisy data for the FWI/EFWI. The noise attenuation may be performed in any stage of the processing scheme described above.

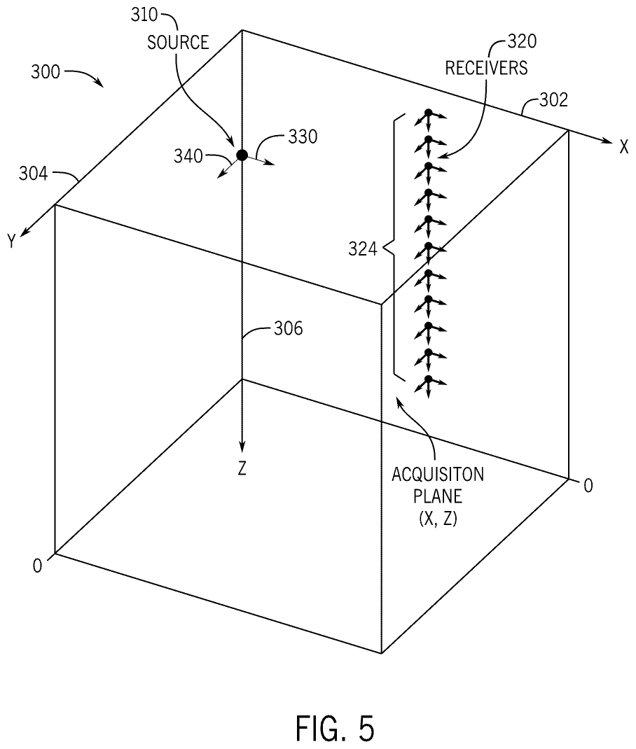

For illustration of the inline/crossline directions, FIG. 5 is a schematic diagram of a crosswell seismic acquisition. The 3D volume is defined by three perpendicular axis 302 (X), 304 (Y), and 306 (Z). An acquisition plane is defined as the X-Z plane. A seismic source 310 (e.g., vertical vibrator, horizontal vibrator) and a receiver array 320 (e.g., including multicomponent geophones or accelerometers) may operate with respect to an inline direction 330 and a crossline direction 340.

For example, for idealistic one-dimensional medium structure, wavefields created by an inline force (e.g., the seismic source 310 applying force along the inline direction 330) has zero crossline components and wavefields created by a crossline force (e.g., the seismic source 310 applying force along the crossline direction 340) has zero inline and vertical components. The inline components may include recorded wavefields corresponding to P-waves and inline SV-waves that propagate with different velocities and polarizations. In certain cases, assumptions (e.g., certain components are zeroes) on the polarization may not be strictly valid due to 3D medium structures or anisotropy beyond VTI, therefore the effects related to the polarization may be neglected during the processing.

In some cases, certain type of sources may not create certain data component(s). In some cases, certain type of the receivers may not measure certain data component(s). For example, a monopole-type of the source may not create a crossline component, and monopole-type of the receiver may not measure the crossline component.

In some cases, orientations of sources (e.g., multicomponent sources such as dual-force sources) and/or receivers (e.g., 3-component geophones) in a borehole may be unknown. In such cases, the seismic survey data containing inline and crossline data components are mixed. A wave decomposition process (e.g., using the method described at process block 218 of FIG. 4) may be desired.

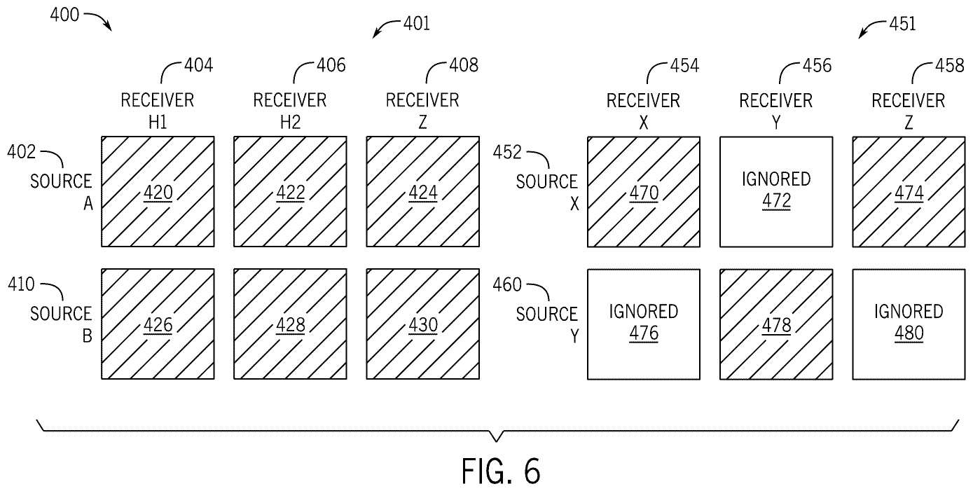

FIG. 6 is a schematic diagram of a wave decomposition 400 including a six-component data orientation. The wave decomposition 400 may depend on source types (e.g., monopole, dipole, quadrupole) that may have different source radiation patterns. In some cases, accurate radiation patterns of the source may be unknown because certain borehole environmental conditions may contribute into the source patterns.

A computing system (e.g., data processing system 80) may perform the wave decomposition 400 based on cross-well data including induced micro-seismic events measured and recorded by the monitoring tool 162 deployed in the monitoring well 130 during the perforation and the stimulations processes of FIG. 2. A diagram 401 illustrates undecomposed components, such as a component 420 (corresponding to a source 402 (Source A) and a horizontal receiver 404), a component 422 (corresponding to the source 402 and a crossline horizontal receiver 406), a component 424 (corresponding to the source 402 and a vertical receiver 408), a component 426 (corresponding to a source 410 (Source B) and the inline horizontal receiver 404), a component 428 (corresponding to the source 410 and the crossline horizontal receiver 406), and a component 430 (corresponding to the source 410 and the vertical receiver 408).

A diagram 451 illustrates decomposed components, such as a component 470 (corresponding to an inline horizontal source 452 (Source X) and an inline horizontal receiver 454), a component 472 (corresponding to the inline horizontal source 452 and a crossline horizontal receiver 456), a component 474 (corresponding to the inline horizontal source 452 and a vertical receiver 458), a component 476 (corresponding to a crossline horizontal source 460 (Source Y) and the inline horizontal receiver 454), a component 478 (corresponding to the crossline horizontal source 460 and the crossline horizontal receiver 456), and a component 480 (corresponding to the crossline horizontal source 460 and the vertical receiver 458).

For orthogonally oriented components, the wave decomposition 400 may be performed as data rotation on source and/or receive sides. A rotation angle may be determined based on a maximum energy criterion or a polarization analysis. The wave decomposition 400 may be applied either sequentially or simultaneously for the sources and receivers' components.

In one embodiment, wavefields created by an inline force (e.g., the inline horizontal source 452 applying force along the inline direction) has zero crossline components, therefore the component 470 is ignored. In one embodiment, wavefields created by an inline force (e.g., the inline horizontal receiver 454 applying force along the crossline) has zero incline and vertical components, therefore the components 476 and 480 are ignored.

In one embodiment, to obtain the wave decomposition 400, the computing system may perform a preprocessing step based on certain assumptions, such as polarizations of first arrivals for direct P-waves and direct SH-waves are in the inline and crossline directions, or a part of the inversion scheme where the part of the inversion is an inversion for the radiation pattern. In some cases, the receiver type may be considered in the inversion scheme.

In one embodiment, a dual-force source (e.g., a downhole dual-force tool) may be used in a cross-well survey. I this case, an orientation of the source components for the dual-force source may be considered. For example, the orientation of the downhole dual-force source tool components may not be orthogonal at the same depth position and an orthogonal rotation procedure may give undesired results, such as in case a dual-force tool rotation in the borehole occurs. A decomposition for non-orthogonal source components may be used. Certain details related to the decomposition for non-orthogonal source components based on data acquired using vertical wells will be described below. For deviated wells, the processing procedure may be modified to include wells' deviation effects.

The decomposition for non-orthogonal source components may include multiple operations. For example, the computing system may determine an arrival window of first P-wave arrivals and apply receiver rotations for the components of the monopole source 402 (Source A) and the monopole source 410 (Source B). An inline receiver-component may include P-wave and SV-wave events and a receiver-crossline component may include SH-wave events.

After the receiver rotations, the computing system may determine an arrival window of the first SH-wave arrival in the receiver-crossline component. The computing system may mix the inline and crossline source components using an equation (1):

$$\begin{matrix}{u}_{x}^{A} = {u}_{x}^{X} cos {φ}^{A} & {u}_{x}^{B} = {u}_{x}^{X} cos {φ}^{B}\end{matrix} , \qquad Eq . ( 1 ) ,$$

$$\begin{matrix}{u}_{z}^{A} = {u}_{z}^{X} cos {φ}^{A} & {u}_{z}^{B} = {u}_{z}^{X} cos {φ}^{B}\end{matrix} ,$$

$$\begin{matrix}{u}_{y}^{A} = {u}_{y}^{Y} sin {φ}^{A} & {u}_{y}^{B} = {u}_{y}^{Y} sin {φ}^{B}\end{matrix} ,$$

where φ^{A} and φ^{B} are orientations of the Source A and Source B components. Here u stands for the wavefield, subscripts x, y, and z stand for inline, crossline and vertical receivers' components and superscripts X, and Y stand for inline and crossline sources components.

The computing system may perform polarization analysis for the Source A and Source B components in an arrival window for P-waves using an equation (2):

$$F = [ \begin{matrix}{u}_{x}^{A} \\ {u}_{x}^{B}\end{matrix} ] = Φ \cdot S \cdot {V}^{′} with Φ = ( \begin{matrix}{Φ}_{11} & {Φ}_{12} \\ {Φ}_{21} & {Φ}_{22}\end{matrix} ) , \qquad Eq . ( 2 )$$

$${u}_{x}^{A} {Φ}_{12} + {u}_{x}^{B} {Φ}_{22} = 0$$

$${Φ}_{12} = - sin {ψ}_{i} , {Φ}_{22} = cos {ψ}_{i} .$$

where the angle φᵢ (i=x or y) is a rotation angle for the orthogonal case and the coefficients Φ₁₂ and Φ₂₂ may nullify a linear combination of the u^{A}ₓ and u^{B}ₓ.

Moreover, the computing system may determine the rotational angle ψₓ in the arrival window of the first SH-wave arrival, solve for orientations φ^{A} and φ^{B}, and reconstruct trajectory of the dual-force source tool rotation. If certain orientations are not determined at certain depth, the computing system may use data interpolated and/or extrapolated from neighboring areas, or knowledge that the Source A and Source B are orthogonal if taken at shifted depths (e.g., at two depth positions).

In one embodiment, the computing system may perform an inversion of the source or receiver components orientations. The orientations angles of sources and/or receivers may be considered as unknowns and included into the inversion.

In one embodiment, the computing system may use modeling algorithms and inversion algorithms that include axial symmetric information. For example, one feature of the FWI/EFWI algorithms is an axial symmetric approach implemented for general types of the radiation patterns of the sources and receivers. This approach may allow for performing computations in two-dimensions (e.g., in radial and vertical dimensions), while modeling three-dimensional point-sources and three-dimensional geometrical effects of the acquisition. For horizontally stratified medium, an axial symmetric solution may include a true solution as in a 3D case.

When performing computations for a particular source and a set of receivers, the computing system may set a vertical axis of symmetry at the source location, use a 2D distribution of medium properties that starts at the source location and goes towards the receivers, and use a 3D medium distribution as the extracted 2D medium rotated over the axis of symmetry and perform the computations.

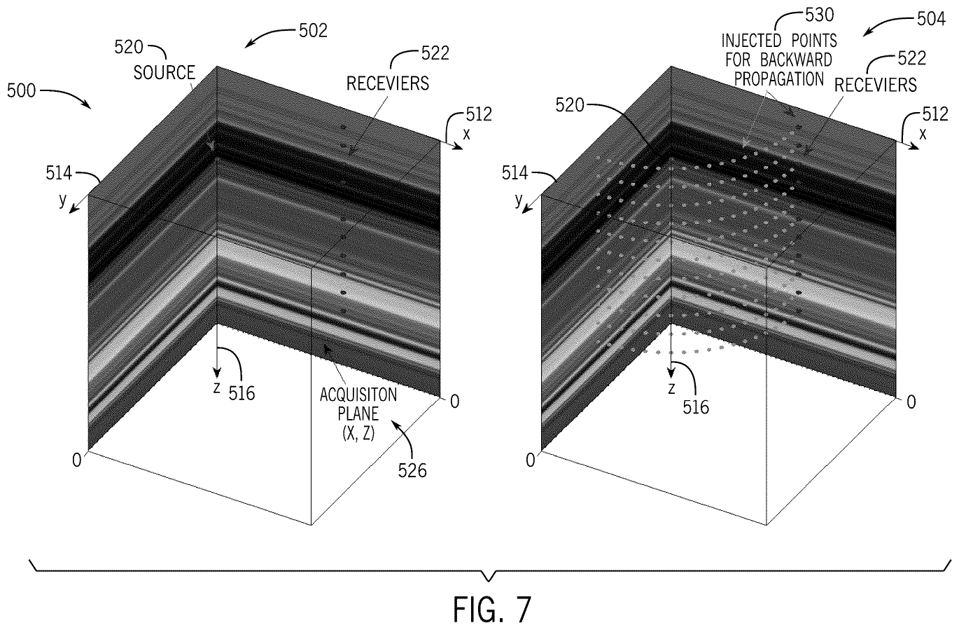

With these in mind, FIG. 7 is a schematic diagram of a two-dimensional (2D) seismic acquisition. The 2D seismic acquisition may be used to solve axial symmetric problems, such as a forward propagation problem shown in a section 502 and a backward propagation problem shown in a section 504. The sections 502 and 504 are constructed with respect to axes 512 (X), 514 (Y), and 516 (Z). The computing system may set a vertical axis of symmetry as the axis 516 (Z) at the source location (e.g., corresponding to a source 520 located at x=0, y=0), use a 2D medium distribution (e.g., s horizontally layered medium containing medium properties) that starts at the source location and goes towards receivers 522, and use a 3D medium distribution as the extracted 2D data rotated over the axis of symmetry and perform the computations.

The source and receivers are in the same plane defined as an acquisition plane 526 (an (X,Z) plane). The 2D seismic acquisition is supplied with the ‘ring’-distributed receivers 530 (indicated as rings with dots) for the backward propagation problem, as shown in the section 504.

The accuracy of an axial symmetric approximation used in the computations may depend on the type of the geological structure, distances from the axis of symmetry to the structural variations and receivers, frequencies of the signals, and so on. For a geology with slight variation of the medium properties in horizontal direction the axial symmetric approximation may yield desired results. For example, certain numerical experiments for tilted formation show desired results for a moderate tilt value for both modeling and inversion. It may be difficult to characterize all applicable cases using the axial symmetric approximation as there are many factors to be considered. The applicability of the axial symmetric approximation may depend on the synthetic modeling and inversion results, data analysis on 3D effects, prior knowledge, and previous experience on the similar scenarios.

The modeling and inversion algorithms may include an axial symmetric forward modeling algorithm. Such algorithm may decompose a solution of wave equations into a set of different Fourier azimuthal harmonics and propagate each harmonic separately using a correspondent equation in radial and vertical coordinates. The separation of the harmonics may be valid for the axial symmetric medium, axial symmetric spatial distribution of the source, and VTI anisotropic medium. The equations of wave propagation may be similar for all harmonics with certain terms containing a coefficient that depends on the azimuthal harmonic number.

In certain cases, the seismic sources may have up to three Fourier harmonics (e.g., monopole-zero harmonic, dipole-first harmonic, quadruple-second harmonic). The wavefields may be decomposed using an equation (3):

$${u}_{α} ( r , θ , z ) = {\hat{u}}_{α} ( r , z ) φ ( θ ) , {σ}_{αβ} ( r , θ , z ) = {\hat{σ}}_{αβ} ( r , z ) φ ( θ ) , \\ α = r , z , αβ = rr , θθ , zz , rz , \qquad Eq . ( 3 )$$

$${u}_{α} ( r , θ , z ) = {\hat{u}}_{α} ( r , z ) ψ ( θ ) , {σ}_{αβ} ( r , θ , z ) = {\hat{σ}}_{αβ} ( r , z ) ψ ( θ ) , α = θ , αβ = r θ , θ z ,$$

Where r is radial coordinate, θ is azimuthal coordinate, z is vertical coordinate, u=(uᵣ, u_{θ}, u_{z}), is displacement vector, σ=(σᵣᵣ, σ_{θθ}, σ_{zz}, σ_{θz}, σ_{rz}, σ_{rθ}) is the stress tensor and φ(θ) and ψ(θ) are azimuthal harmonics.

Table 1 is a summary of parameters for different source types. The table 1 lists all possible types of the sources, including force types and moment tensor types (12 in total), azimuthal dependence of the wavefield components (φ(θ) and ψ(θ) for each source type), and correspondence between source description in Cartesian and cylindrical coordinates. The wave equations are written further for u=(uᵣ, u_{θ}, u_{z}) and σ=(σᵣᵣ, σ_{θθ}, σ_{zz}, σ_{θz}, σ_{rz}, σ_{rθ}) that do not depend on the azimuthal coordinate θ. Inline and crossline sources of the same type from Table 1 may form pairs, which may be obtained from each other by rotation on ±π/2. Each pair (e.g., inline and crossline forces) may be computed simultaneously.

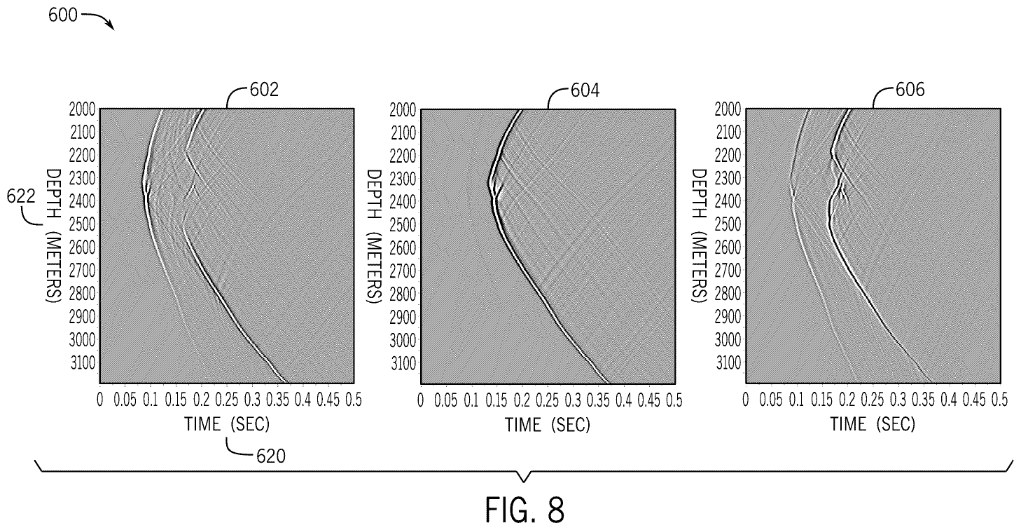

FIG. 8 depicts examples 600 of computed wavefields using a wave decomposition (e.g., the wave decomposition 400 described above with respect to FIG. 6). The examples include results from a 3-component modeling using a layered model for a cross-well acquisition including multiple vertical wells. An example 602 shows computed wavefields corresponding to an inline source and inline receivers. An example 604 shows computed wavefields corresponding to a crossline source and crossline receivers. An example 600 shows computed wavefields corresponding to an inline source and vertical receivers. The computed wavefields in each example are plotted with respect to an axis 620 (representing time in second) and an axis 622 (representing depth in meter)

TABLE 1
Summary of the parameters for different source types.

| MONOPOLE | CARTESIAN | CYLINDRICAL | κ_{θ} | φ(θ), Ψ(θ) |
|---|---|---|---|---|
| FORCE: VERTICAL | f_{z} | \hat{f}_{z} | κ_{θ} = 0 | φ(θ) ≡ 1 |
| MT: VERTICAL | m_{zz} | \hat{m}_{zz} | | Ψ(θ) ≡ 0 |
| MT: HORIZONTAL EXPLOSION | mₓₓ + m_{yy} | \hat{m}ᵣᵣ + \hat{m}_{θθ} | | |
| MT: ASYMMETRIC INLINE | m_{xy} − m_{yx} | \hat{m}_{rθ} − \hat{m}_{θr} | | φ(θ) ≡ 0 |
| CROSSLINE (PURE SHEAR) | | | | Ψ(θ) ≡ 1 |
| DIPOLE: INLINE | | | | |
| FORCE: IN-LINE | fₓ | \hat{f}ᵣ − \hat{f}_{θ} | κ_{θ} = 1 | φ(θ) ≡ cos θ |
| MT: SYMMETRIC VERTICAL | m_{xz} + m_{zx} | \hat{m}_{rz} + \hat{m}_{zr} − \hat{m}_{rθ} − \hat{m}_{θr} | | Ψ(θ) ≡ sin θ |
| INLINE | | | | |
| MT: ASYMMETRIC VERTICAL | m_{xz} − m_{zx} | \hat{m}_{rz} − \hat{m}_{zr} − \hat{m}_{rθ} + \hat{m}_{θr} | | |
| INLINE | | | | |
| DIPOLE: CROSSLINE | | | | |
| FORCE: CROSSLINE | f_{y} | \hat{f}ᵣ + \hat{f}_{θ} | κ_{θ} = −1 | φ(θ) ≡ sin θ |
| MT: SYMMETRIC VERTICAL | m_{yz} + m_{zy} | \hat{m}_{rz} + \hat{m}_{zr} + \hat{m}_{rθ} + \hat{m}_{θr} | | Ψ(θ) ≡ cos θ |
| CROSSLINE | | | | |
| MT: ASYMMETRIC VERTICAL | m_{yz} − m_{zy} | \hat{m}_{rz} − \hat{m}_{zr} + \hat{m}_{rθ} − \hat{m}_{θr} | | |
| CROSSLINE | | | | |
| QUADRUPLE: INLINE | | | | |
| MT: DIAGONAL INLINE | mₓₓ − m_{yy} | \hat{m}ᵣᵣ − \hat{m}_{rθ} − \hat{m}_{θr} − \hat{m}_{θθ} | κ_{θ} = 2 | φ(θ) ≡ cos 2θ |
| NEGATIVE CROSSLINE | | | | Ψ(θ) ≡ sin 2θ |
| QUADRUPLE: CROSSLINE | | | | |
| MT: SYMMETRIC INLINE | m_{xy} + m_{yx} | \hat{m}ᵣᵣ + \hat{m}_{rθ} + \hat{m}_{θr} − \hat{m}_{θθ} | κ_{θ} = −2 | φ(θ) ≡ sin 2θ |
| CROSSLINE | | | | Ψ(θ) ≡ cos 2θ |

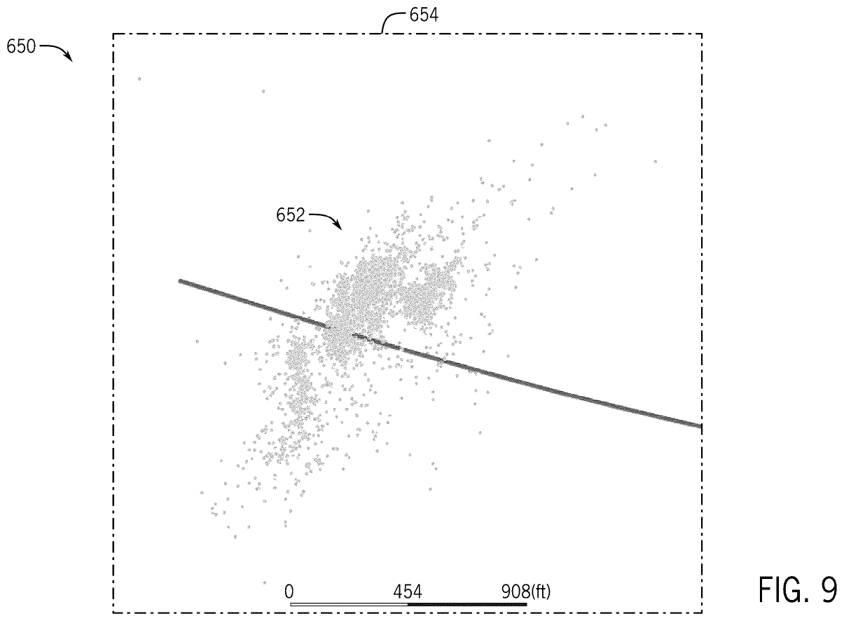

FIG. 9 is an example plot 650 illustrating a cloud of micro-seismic events 652 distributed in a two-dimensional plane 654 from a Barnett shale fracturing treatment. In the example, receivers may be considered to be azimuthally distributed and backward propagated residuals are injected using correspondent azimuthal harmonics.

In one embodiment, the computing system may perform a gradient computation using an adjoint method for axial symmetric cases. The gradient computation may follow the axial symmetric approach described above. For example, a resulting backward-propagated field may be injected in such a way that a backward-propagated field has the same harmonic distribution as a forward-propagated field. A gradient formula may be formulated in radial and vertical coordinates. The gradient formula may be derived from a 3D case with considering a known azimuthal dependence on the wavefields.

In one embodiment, the computing system may perform a source modeling. For example, the sources may include a spatial distribution (e.g., axially symmetric distribution), a radiation pattern, and wavelets as set in elastic wave equations. In some cases, the source modeling may not include modeling wellbore conditions and tool effects. In some cases, the sourced modeling may include or approximate the wellbore conditions and tool effects in terms of the spatial distribution, the radiation pattern, and the wavelets. The source modeling may apply to any type of the source that may be described in terms of the spatial distribution, the radiation pattern, and the wavelets, such as the downhole dual force tool and piezo electric source.

In one embodiment, the computing system may perform a receiver modeling. The receivers may be any type of receivers that may be solved by the elastic wave equations. For example, the receivers may include single/multi-component geophones, accelerometers, distributed acoustic sensing (DAS) sensors, and the like.

In case of using the DAS sensors, the computing system may perform the receiver modeling based on fiber-optic data acquired by the DAS sensors. The fiber-optic data may be modeled as strain/strain rate integrated along a cable (fiber-optic cable) direction using, for example, an equation (4):

$${d}_{DAS} ( {x}_{rcv} ) = {\int }_{τ ∈ [ {x}_{rcv} - G / 2 , {x}_{rcv} + G / 2 ]} {ε}_{ττ} d τ . \qquad Eq . ( 4 ) ,$$

where the strain ε_{ττ} along the fiber is integrated along the cable within the gauge length G. Parameter τ parametrizes the fiber. The gauge length may be hardware fixed or adjusted at the data processing stage.

In the scope of the axial symmetric approach, the strain along the cable may be computed considering the deviation of the fiber in the azimuthal direction. In the cylindrical coordinates (r, θ, z), assuming that the wave propagation is axially symmetric, as shown in equation (5):

$${ε}_{ττ} = {\tilde{τ}}_{r}^{2} {ε}_{rr} + {\tilde{τ}}_{θ}^{2} {ε}_{θθ} + {\tilde{τ}}_{z}^{2} {ε}_{zz} + 2 {\tilde{τ}}_{r} {\tilde{τ}}_{z} {ε}_{rz} . \qquad Eq . ( 5 ) ,$$

where the parameters (τᵣ, τ₇₄ , τ_{z}) correspond to the cable deviation in the coordinate system going through the axis of symmetry and aligned with the receiver position, as shown in equation (6):

$${\tilde{τ}}_{r} = {τ}_{x} cos \tilde{θ} + {τ}_{y} sin \tilde{θ} , \qquad Eq . ( 6 ) .$$

$${\tilde{τ}}_{θ} = {τ}_{x} sin \tilde{θ} - {τ}_{y} cos \tilde{θ} ,$$

$${\tilde{τ}}_{z} = {τ}_{z} .$$

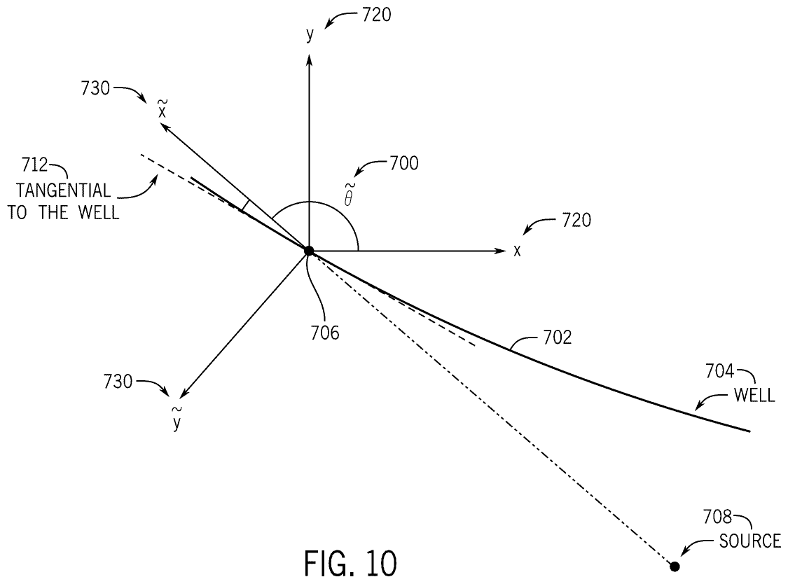

FIG. 10 is a schematic diagram Illustrating an azimuthal angle (θ) 700 definition projected on a horizontal plane. Such angle definition is used in the equations described above. Receivers (e.g., DAS sensors) are deployed along a well trajectory 702 of a well 704. For example, FIG. 10 shows a considered receiver 706 and a source 708. A line 712 represents a tangential direction (in horizontal plane) of the well 704 and intersects the well trajectory 702 at the receiver point (τₓ, τ_{y}) in a global coordinate system with respect to axes X and Y. The azimuthal angle (0) 700 defines a rotation of global coordinates (x, y) 720 to local coordinates (\hat{x}, \tilde{y}) 730 associated with the receiver 706. Values τᵣ, and τ_{θ} in equation (6) are the directions of the tangential direction τ of the well 704 in a local coordinate system with respect to axes \hat{x} and \tilde{y}.

This approach assumes a good coupling of the optical fiber to the well. Effects of variable coupling may be incorporated with transfer function adjusted in the inversion or chosen empirically. A simple example of the compensation of the variable coupling is a scaling factor between different cable length intervals.

In one embodiment, the computing system may use an adjoint formulation of FWI that is designed for strain or strain rate and does not include a transformation of data (e.g., DAS data) into velocities or other domains. The gradient computation mention previously may be done by an adjoint method. For measurements without DAS, the gradient is a cross-correlation in time of a forward propagated field and backward propagated residuals. For DAS measurements, an adjoint field is spatially averaged to account for a gauge length averaging in DAS and injected as a moment tensor source with the radiation pattern depending on a well deviation. The adjoint formulation of FWI/EFWI is applicable to cross-well seismic data with formula modifications (e.g., including an azimuthal harmonic dependence).

In some cases, an axial symmetric approximation may not be desired for certain geological scenarios and/or may be validated before an application. For example, 2D-Cartesian and full 3D formulations may be used for FWI/EFWI or validation of the applicability of the axial symmetric approach.

In one embodiment, the computing system may apply the FWI/EFWI algorithms described above to different types of measurements (e.g., different source and receiver types). For example, such FWI/EFWI algorithms may be used to process DAS data and conventional multi-component data.

In one embodiment, before starting the inversion, the computing system may adjust field data and an initial source wavelet to comply with the FWI/EFWI mathematical formulations. For example, the adjustment may include an additional one-time or two-time derivatives that is applied to certain types of the data or to the source wavelet.

In one embodiment, the computing system may estimate the source wavelet based on first arrivals in the field data when no information about a source wavelet function is available. Alternatively, the computing system may use a theoretical estimation of the source wavelet function to estimate the source wavelet. The source wavelet estimation may depend on procedures of data processing. The theoretical estimation of source wavelet may go through the same procedures as the filed data. For example, for a vibrator source, the field data may be correlated with a sweep function, thus the estimation of the source wavelet is an autocorrelated sweep. The estimated source wavelet function may be further inverted to compensate for the unknown wellbore or tool conditions.

Source radiation pattern is a general force or moment tensor type. Source radiation pattern may be fixed based on the knowledge of the source. When the radiation pattern of the source is unknown (or lack of accuracy), the computing system may include the components of the source radiation patterns in the FWI/EFWI inversion parameters.

In one embodiment, the computing system may apply a receiver transfer function to the seismic data to account for sensors response and to compensate for wellbore or other conditions. In one embodiment, the computing system may run the FWI/EFWI algorithms in a physical or a reciprocal way. For example, the computing system may run the algorithms by change of the sources and receivers with a correspondent change of the radiation pattern. In one embodiment, the computing system may limit the inversion to a specified frequency interval. For example, both the field data and the initial source wavelet may be filtered to a specific frequency interval.

In one embodiment, the computing system may run the FWI/EFWI using a portion of the field data and a data weighting. For example, the computing system may mute (e.g., in time domain) certain portion(s) of the field data and only use the portion of data within a time window that corresponds to events of interest. For another example, the computing system may exclude non-reflection data (e.g., direct waves, refractions) when the inversion is limited to reflections. In some cases, the data from different sources or receivers, or different data components may be weighted differently. The implementation in such cases is based on the construction of the correspondent data covariance matrix that goes into an FWI/EFWI cost function.

In one embodiment, the computing system may apply a spatial smoothing to add pre-known knowledge (e.g., geology of a survey area) or to stabilize the inversion. The computing system may apply a model weighting (e.g., applying a spatial weighting to the model update). In such cases, the computing system may use a model covariance matrix which may go into the FWI/EFWI cost function for zero regularization but may be used as a gradient preconditioner.

### Multiparameter Inversion

In one embodiment, the computing system may perform a multi-parameter inversion. The multi-parameter inversion may have certain challenges because the seismic data may not be sensitive or may have low sensitivity to certain medium properties. Sensitive parameters may include non-trivial combinations of certain spatial combinations of the physical parameters. Based on different applications, the computing system may use one or more methods, such as applying a parameters scaling to balance the update for different physical properties, using a correlation between different medium parameters based on their sensitivity or rock physics models, inverting for all or a portion of the medium properties simultaneously or sequentially, adjusting parameterization, reparametrizing inverted parameters for the rock properties, applying different smoothing for different parameters to comply with the resolution, and so on.

In one embodiment, the computing system may perform an inversion workflow including several stages. In each stage, the computing system may set a frequency interval and define the inversion parameters. An output FWI/EFWI model in one stage may be used as an input model to the next stage. The workflow and the parameters on each stage may be adjusted for different cases. The computing system may start with a default workflow and a set of parameters based on the previously considered testcases. Additional adjustments may be done by computing a set of inversion scenarios for a subset of the real data using coarse computational grid to speed up. After promising scenario/scenarios are set, the computations are performed for a full set of the data and fine computational grid.

In one embodiment, the computing system may perform a quality control (QC) procedure in each stage of the inversion workflow. For example, between different inversion stages, the computing system may perform the QC by monitoring and assessing certain criteria, such as a misfit reduction of the cost function and a misfit for each source separately, a cycle skipping, convergences of certain particular events (e.g., first arrivals), convergences of the whole wavefield, parameter updates (e.g., being physically and structurally reasonable), source wavelet updates (e.g., being reasonable in amplitude, frequency content, and temporal distribution), model update (e.g., having considerable changes), travel time convergences, inversion artefacts, and so on. Some of these criteria may be checked automatically, other criteria may be checked with user interactions (e.g., user-provided inputs for the inversion workflow and/or parameters tuning).

The output from the FWI/EFWI may include an inversion multi-parameter model including various inverted parameters described above. The inversion multi-parameter model may be used for migrations to produce enhanced subsurface images indicative of various subsurface properties (e.g., velocities, densities, attenuations, horizons, faults, anisotropies), which may be used for hydraulic fracturing monitoring, reservoir characterization, geological interpretation, monitoring time-lapse changes, and so on. In certain cases, the inversion multi-parameter mode may be interpreted structurally or in terms of the rock properties.

The systems and methods described in present disclosure provide various techniques using cross-well seismic data (and additional data such as well logs and VSP data) to image reservoir structures illuminated with sources located in a lateral well and receivers located in one or more nearby lateral wells. The techniques may include a variety of numerical FWI algorithms and workflows based on an inversion engine (e.g., an elastic vertical transverse isotropy (VTI) anisotropic full waveform inversion (EFWI)) for data acquired with one or more cross-well seismic surveys. The inversion engine may include a wave propagation modeling that may accurately account for physical phenomena of seismic waves (e.g., P-waves, S-waves including SH and SV waves, direct waves, up-going and/or down-going waves, reflected waves, converted waves, multiple events, head waves, guided modes), which propagate in subsurface. The inversion engine may utilize all or a subset of the seismic waves to generate maps of the elastic properties (e.g., P-wave and/or S-wave velocities, VTI anisotropy parameters, bulk density, attenuation).

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function]. . . ” or “step for [perform]ing [a function]. . .”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method, comprising:
constructing, via an inversion engine, an initial subsurface model indicative of a plurality of parameters associated with a subsurface formation in an area;
recording, via a monitoring tool deployed in a second well located in the area, a first plurality of seismic waves propagating through a fractured area as a first set of perforation events that occur when a first well is perforated via perforation equipment deployed in the first well;
recording, via the monitoring tool, a first plurality of induced micro-seismic waves as a first set of induced micro-seismic events that occur when the first well is stimulated via stimulation equipment deployed in the first well;
generating, via a seismic recorder, cross-well seismic data comprising the first set of perforation events and the first set of induced micro-seismic events; and
performing, via the inversion engine, an elastic full waveform inversion based on the cross-well seismic data to update the initial subsurface model, wherein updating the initial subsurface model comprises inverting the plurality of parameters and generating a final subsurface model.

2. The method of claim 1, wherein the inversion engine is configured to use the cross-well seismic data to image the fractured area illuminated by the first plurality of seismic waves propagating through the fractured area based on the final subsurface model, wherein imaging the fractured area generates images indicative of characterizations of physical and structural properties of the fractured area.

3. The method of claim 1, comprising:
recording, via the monitoring tool, a second plurality of seismic waves generated when a third well located in the area is perforated, as a second set of perforation events; and
recording, via the monitoring tool, a second plurality of induced micro-seismic waves as a second set of induced micro-seismic events that occur when the third well is stimulated, wherein stimulating the third well creates the fractured area comprising a plurality of fractures.

4. The method of claim 3, wherein the first well, the second well, and the third well comprise lateral wells.

5. The method of claim 3, wherein the monitoring tool is configured to:
register the second set of perforation events to obtain a calibration point;
construct an updated subsurface model based on the calibration point; and
determine one or more stimulation parameters for stimulating the third well.

6. The method of claim 5, wherein the updated subsurface model comprises a plurality of updated parameters based on the second set of perforation events, wherein the one or more stimulation parameters comprise an amount of proppant usage for stimulating the third well.

7. The method of claim 3, wherein the third well is perforated and stimulated via a first multi-stage hydraulic fracturing treatment process comprising:
perforating a first stage of the third well to create flow paths between a reservoir in the subsurface formation and a wellbore of the third well;
stimulating the first stage by injecting a pressurized fracturing fluid into the reservoir via the wellbore and the flow paths, wherein injecting the pressurized fracturing fluid creates a subset of fractures of the plurality of fractures in the fractured area;
perforating a second stage of the third well to create additional flow paths between the reservoir and the wellbore; and
stimulating the second stage by injecting the pressurized fracturing fluid into the reservoir via the wellbore and the additional flow paths, wherein injecting the pressurized fracturing fluid creates an additional subset of fractures of the plurality of fractures in the fractured area.

8. The method of claim 3, wherein the inversion engine comprises a plurality of algorithms and a plurality of workflows, wherein the plurality of algorithms comprises an elastic vertical transverse isotropy (VTI) anisotropic full waveform inversion algorithm based on wave propagation modeling, wherein the VTI anisotropic full waveform inversion algorithm is configured to account for the first plurality of seismic waves and the second plurality of seismic waves.

9. The method of claim 8, wherein the first plurality of seismic waves and the second plurality of seismic waves comprise compressional waves, shear waves, direct waves, up-going waves, down-going waves, reflected waves, refracted waves, converted waves, multiple events, head waves, and guided modes.

10. The method of claim 9, wherein the inversion engine is configured to use the cross- well seismic data to generate a plurality of maps indicative of the plurality of parameters, wherein the plurality of parameters are indicative of a plurality of elastic properties of the subsurface formation, wherein the plurality of elastic properties comprises compressional wave velocity, shear wave velocity, VTI anisotropy parameters, bulk density, or attenuation, and wherein the plurality of elastic properties is used in CO2 storage or geothermal applications.

11. The method of claim 10, wherein the inversion engine is configured to generate the plurality of maps based on the cross-well seismic data and additional data, wherein the additional data comprises the second set of perforatino events, or seismic data acquired by the monitoring tool in response to seismic waves generated from one or more seismic sources deployed in a fourth well located in the area, or adjacent well data acquired by one or more additional monitoring tools deployed in one or more adjacent wells located in the area, or time-lapsed data acquired before, during, and after perforating and stimulating the first well, or well log data from one or more log wells located in the area, or vertical seismic profile (VSP) data from one or more VSP wells located in the area, or any combination thereof.

12. A system, comprising:
a seismic data acquisition system configured to acquire cross-well seismic data in an area comprising a subsurface formation, wherein the seismic data acquisition system comprises:
perforation equipment deployed in a first well located in the area and configured to perforating a first well located in the area to generate a plurality of seismic waves propagating through a fractured area in the subsurface formation; and
monitoring equipment deployed in a second well located in the area and configured to record the plurality of seismic waves as a set of perforation events; and
a seismic data processing system configured to process the cross-well seismic data, wherein the seismic data acquisition system comprises:
a parameter setup module configured to define and initialize a plurality of processing parameters and a plurality of geological parameters associated with the subsurface formation in an area;
a model building module configured to construct an initial subsurface model indicative of the plurality of geological parameters;
a data decomposition module configured to decompose at least a portion of the cross-well seismic data into inline and crossline components based on the plurality of processing parameters;
a plurality of denoise modules configured to reduce seismic noises contaminations in the inline and crossline components based on the plurality of processing parameters;
an inversion module configured to perform an elastic full waveform inversion to generate a final subsurface model based on denoised inline and crossline components and the plurality of processing parameters, wherein the elastic full waveform inversion inverts the plurality of geological parameters to update the initial subsurface model; and
an imaging module configured to perform a tomographic imaging of hydraulic fracture characterizations based on the final subsurface model to generate three-dimensional images associated with the fractured area.

13. The system of claim 12, wherein the seismic data acquisition system comprises stimulation equipment, wherein the fractured area is fractured by:
perforating, using the perforation equipment deployed in a third well located in the area, the third well to create flow paths between a reservoir in the subsurface formation and a wellbore of the third well; and
stimulating, using the stimulation equipment deployed in the third well, the third well to create a plurality of fractures in the fractured area, wherein the stimulation equipment is configured to inject a pressurized fracturing fluid into the reservoir via the wellbore and the flow paths.

14. The system of claim 12, wherein the three-dimensional images are indicative of a geometry of the fractured area, wherein the geometry comprise shape and structure information of the fractures, wherein the imaging module is configured to generate the three-dimensional images by:
obtaining a first seismic tomographic velocity image or an attenuation image based on the initial subsurface model and prior to perforating the first well; and
obtaining a second seismic tomographic velocity or attenuation image based on the final subsurface model and after perforating the first well.

15. The system of claim 12, wherein the monitoring equipment comprises geophones, accelerometers, hydrophones, fiber-optic sensors, or any combination thereof, wherein the monitoring equipment is configured to move along the second well.

16. The system of claim 15, wherein the monitoring equipment is configured to record additional seismic data in response to additional seismic waves induced by controlled seismic energy generated from one or more additional downhole or surface seismic sources deployed in one or more adjacent wells in the area and propagating through the fractured area, wherein the one or more additional downhole or surface seismic sources comprise a seismic vibrator, a thumper, a dual-force type of source, or any combination therefore.

17. A non-transitory computer-readable medium comprising instructions that, when executed by one or more processors, cause the one or more processors to:
receive cross-well seismic data acquired from a plurality of lateral wells located in an area comprising a subsurface formation;
determine a plurality of processing parameters and a plurality of geological parameters associated with the subsurface formation based on the cross-well seismic data;
construct an initial subsurface model indicative of the plurality of geological parameters;
decompose at least a portion of the cross-well seismic data into inline and crossline components based on the plurality of processing parameters;
denoise the inline and crossline components to reduce seismic noise contaminations;
invert the plurality of geological parameters to update the initial subsurface model based on the denoised inline and crossline components using an elastic full waveform inversion;
generate a final subsurface model based on the inverted plurality of geological parameters; and
generate subsurface images associated with a fractured area comprising a plurality of fractures in the subsurface formation.

18. The non-transitory computer-readable medium of claim 17, comprising the instructions that, when executed by the one or more processors, cause the one or more processors to estimate changes of the subsurface formation based on elastic waves propagations in a seismic frequency range having limited seismic attenuations.

19. The non-transitory computer-readable medium of claim 17, comprising the instructions that, when executed by the one or more processors, cause the one or more processors to invert the plurality of geological parameters based on elastic wave modeling, wherein the elastic wave modeling and inverting the plurality of geological parameters are based on source and receiver mechanism comprising radiation patterns, spatial distributions, source wavelets, and transfer functions.

20. The non-transitory computer-readable medium of claim 19, comprising the instructions that, when executed by the one or more processors, cause the one or more processors to use seismic attenuations or seismic dispersions in the cross-well seismic data to perform the elastic wave modeling and inverting the plurality of geological parameters.
